(19) United States
(12) Patent Application Publication
(10) Pub. No.: US 2024/0311153 A1
(43) Pub. Date: Sep. 19, 2024

(54) COLLECTIVE COMMUNICATION AS A MULTI-COMMODITY FLOW PROBLEM

(71) Applicant: Microsoft Technology Licensing, LLC, Redmond, WA (US)

(72) Inventors: Behnaz ARZANI, Redmond, WA (US); Siva Kesava Reddy KAKARLA, Bellevue, WA (US); Miguel OOM TEMUDO DE CASTRO, Cambridge (GB); Srikanth KANDULA, Redmond, WA (US); Saeed MALEKI, Seattle, WA (US); Luke Jonathon MARSHALL, Redmond, WA (US)

(73) Assignee: Microsoft Technology Licensing, LLC, Redmond, WA (US)

(21) Appl. No.: 18/331,846

(22) Filed: Jun. 8, 2023

Related U.S. Application Data
(60) Provisional application No. 63/488,712, filed on Mar. 6, 2023.

(51) Int. Cl. G06F 9/30; G06F 9/38

(52) U.S. Cl. CPC G06F 9/3005; G06F 9/3877

(57) ABSTRACT

A method for scheduling a coordinated transfer of data among a plurality of processor nodes on a network comprises operating a multi-commodity flow model subject to a plurality of predetermined constraints. The model is configured to (a) receive as input a set of demands defining, for each of the plurality of processor nodes, an amount of data to be transferred to that processor node, (b) assign a plurality of paths linking the plurality of processor nodes, and (c) emit a schedule for transfer of the data along the plurality of paths so as to minimize a predetermined cost function, wherein the schedule comprises at least one store-and-forward operation and at least one copy operation.

### CROSS REFERENCE TO RELATED APPLICATION

This application claims priority to U.S. Provisional Patent Application Ser. No. 63/488,712, filed 6 Mar. 2023, the entirety of which is hereby incorporated herein by reference for all purposes.

### BACKGROUND

A sophisticated machine-learning (ML) model, such as a language model, may be trained using multiple chassis of graphics processing units (GPUs). Each GPU may process a different file of labeled training data, to determine a subset of the weighting factors of the model. Each GPU also may distribute the weights it has determined to many other GPUs on the training network, often across chassis borders. Generally speaking, the paths that the training data and weighting factors travel over the various nodes of the network, and the schedules that control the data transfer, affect the overall efficiency of the training process. Complex scheduling methods are used to avoid exceeding the capacity limitations of the various nodes while also discouraging underutilization of any network resource.

### SUMMARY

One aspect of this disclosure relates to a method for scheduling a coordinated transfer of data among a plurality of processor nodes on a network. The method comprises operating a multi-commodity flow model subject to a plurality of predetermined constraints, the model being configured to (a) receive as input a set of demands defining, for each of the plurality of processor nodes, an amount of data to be transferred to that processor node, (b) assign a plurality of paths linking the plurality of processor nodes, and (c) emit a schedule for transfer of the data along the plurality of paths so as to minimize a predetermined cost function, wherein the schedule comprises at least one store-and-forward operation and at least one copy operation.

Another aspect of this disclosure relates to a communication scheduler for a machine-learning collective of a plurality of graphics processing unit (GPU) clusters arranged on a network. The communication scheduler comprises an input engine, an output engine, and a multi-commodity flow model. The input engine is configured to furnish a set of demands defining, for each of the plurality of GPUs, an amount of data to be transferred to that GPU. The multi-commodity flow model is formulated to operate within a plurality of predetermined constraints and configured to (a) receive the set of demands as input from the input engine, (b) assign a plurality of paths linking the plurality of GPUs, and (c) emit a schedule for transfer of the data along the plurality of paths so as to minimize a predetermined cost function, wherein the schedule comprises at least one store-and-forward operation and at least one copy operation. The output engine is configured to output the schedule, together with an optimality-gap guarantee for the schedule.

This Summary is provided to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any or all disadvantages noted in any part of this disclosure.

### BRIEF DESCRIPTION OF THE DRAWINGS

FIG. 1 illustrates, by way of example, certain advantages of data-transfer scheduling in accordance with aspects of this disclosure.

FIG. 2 shows the relative error in the algorithm bandwidth estimate (the output buffer size/transmission time) of comparative collective schedules.

FIG. 3 provides an examples of why integer variables are used to track each chunk of data in accordance with aspects of this disclosure.

FIG. 4 compares the algorithmic bandwidth of TE-CCL and TACCL schedulers.

FIG. 5 compares the solver time of TE-CCL and TACCL schedulers.

FIG. 6 provides two plots comparing TACCL and TE-CCL for ALLTOALL demands with different number of chassis.

FIG. 7 illustrates a technical benefit of the copy operation: for large transfers, copy helps finish the transfer faster.

FIG. 8 shows the impact of small versus large epochs on the solver speed (a) and solution quality (b).

FIG. 9 shows the impact of buffers on (a) solver time and (b) solution quality.

FIG. 10 shows aspects of an example method for scheduling a coordinated transfer of data among a plurality of processor nodes on a network.

FIG. 11 shows aspects of an example communication scheduler for an ML collective.

FIG. 12 provides a schematic drawing of a computer system.

FIG. 13 shows aspects of time progression between rounds using an implementation of the A* scheduler herein.

FIG. 14 provides an example algorithm for finding the number of epochs to run in certain optimizations.

### DETAILED DESCRIPTION

Communication schedulers proposed recently for machine-learning (ML) collectives do not scale to increasing problem sizes which arise from training larger models. These schedulers also may produce suboptimal schedules. In comparison, the TECCL model herein returns higher quality schedules—e.g., finishes collectives faster and/or sends fewer bytes—and does so more quickly and on larger topologies. Disclosed herein are results on many different GPU topologies, which show substantial improvement over state-of-the-art communication schedulers.

### 1. Introduction

Near-optimal collective communication optimizers [Ref. 1], [Ref. 2], [Ref. 3], which optimize the communication routes and schedules of distributed training, cannot scale to meet the demands of cloud operators. This is because cloud operators run large, multi-tenant GPU clusters where training jobs are distributed over many GPUs. Tools that find optimum topologies or hardware architectures, or co-optimize various aspects of distributed training [Ref. 4], [Ref. 5], [Ref. 6] also rely on communication optimizers and call them repeatedly during a given search.

Without communication optimization, a GPU cluster spends significant time with idle GPUs: prior work reports that the GPUs in BERT [Ref. 7] and Deep-Light [Ref. 8], respectively, spent 11% and 63% of their operating time idle [Ref. 1]. The problem becomes worse as faster GPUs are employed. Current communication optimizers leave significant room for improvement; it is shown for example that the performance of state-of-the-art solutions such as TACCL [Ref. 1] can be better than doubled on a two-chassis NDv2 topology [Ref. 9].

According to the methods disclosed herein, near-optimal collective communication optimizers that model the problem imperfectly but optimally solve their model (e.g., SCCL [Ref. 2]) are scaled for large GPU collectives. Significantly improved runtime makes them more usable as part of other collective optimizers, such as [Ref. 5], [Ref. 4], [Ref. 6]. One goal of this disclosure is to improve the solution quality of state-of-the-art heuristics (e.g., TACCL [Ref. 1]) while maintaining the same ability to scale.

The input to a collective communication optimizer is a ‘demand’ (e.g., ALLTOALL, ALLGATHER, ALLREDUCE)—a set of interconnected GPUs where each GPU has a certain amount of data to send to other GPUs in the interconnect. The goal of the optimizer is to produce routes and schedules that either maximize bandwidth utilization [Ref. 3] or minimize job completion time [Ref. 1], [Ref. 2] for the input demand, or both.

Near-optimal optimizers (e.g., [Ref. 2]) apply to a single chassis [Ref. 2]. In contrast, operators require solutions that scale to topologies with 30 to 60 chassis and project larger topologies [Ref. 10]. Heuristics scale but often produce highly sub-optimal solutions [Ref. 3], [Ref. 1]. This is becoming a problem as topologies grow and more users share the same network.

SCCL cannot scale because it uses SMT solvers [Ref. 11]. The heuristics avoid SMT solvers and scale better but fail to account for one or more factors—e.g., identifying where traffic should be copied inside the network, enforcing synchronization barriers, and properly accounting for latency of transfers. They produce sub-optimal solutions as a result.

A different approach is disclosed herein. TE-CCL is based in part on modeling the problem of collective-communication optimization via techniques from a class of problems known as ‘multi-commodity flow’. Operators use multi-commodity flow problems in traffic engineering (TE) and use flow conservation constraints to model the flow of traffic—e.g., they assign paths to maximize a cost function [Ref. 12]. In addition, they take a set of demands as input and produce routes and schedules that optimize various objectives. Nevertheless, the collective problem has features that are not present in a traditional multi-commodity flow model.

A first distinguishing feature is that of temporal variations. Multi-commodity flow problems assume ‘sustained demand’. Such problems rely on a continuous flow of data between a source and destination (for several minutes), and this is why the demand in these problems is a bandwidth request (with units such as bits/sec). However, GPUs in a collective have finite data to send; the demand in these problems is a transfer request (with units such as bits). Accordingly, it is not generally possible to minimize the transfer time by minimizing delay on the longest path, as traditional flow problems do. In other words, it is not possible to assume an uninterrupted flow of traffic for the purpose of approximating the delay cost of transfers (Section 2).

A second distinguishing feature is desirability of supporting ‘store’ and ‘forward’ operations. Traditional flow problems [Ref. 12] do not model caches. It is shown in Section 5 that the solver can find schedules faster by using the available memory in GPUs.

A third distinguishing feature is that of supporting ‘copy’ operations. Unlike typical use cases for the network flow formulation—e.g., in the TE context [Ref. 13], [Ref. 14]—collective communication often multicasts the same data to multiple parties, which requires the model to appropriately copy data within the network and to adjust the traditional flow conservation constraints accordingly.

Some prior approaches extend multi-commodity flow problems—e.g., Calendaring [Ref. 15] supports deadlines on fixed-size transfers, NetStitcher [Ref. 16] allows for store-and-forward, and several multicast TE works [Ref. 17], [Ref. 18] support copying (Section 6). Nevertheless, it is non-trivial to combine these techniques to support all three dimensions without affecting scalability. The approach herein adapts multi-commodity flow problems to support all three dimensions and thereby solve the general collective-communication optimization problem. The solution disclosed is a scalable, mixed-integer linear program with optimality gap guarantees based on the primal-dual theorem [Ref. 12]. It is shown that this solution scales to much larger collectives than techniques such as TACCL [Ref. 1] and SCCL [Ref. 2] and improves the solution quality. For certain collectives the solution can be scaled still further by converting the MILP into an LP by removing all integer variables. In the general case, it is possible to improve scalability by partitioning the problem in time.

TE-CCL's solutions match the solution quality of SCCL and outperform the quality of state-of-the-art solutions such as TACCL and shortest-path schedules [Ref. 6]. A minimum two-fold performance improvement is achieved on the same two-chassis NDv2 topology that TACCL uses. The improvement is achieved because the optimization models the end-to-end problem, whereas prior approaches contain consecutive optimizations that only see a partial view of the problem at each stage. TECCL also adds support for copy and store-and-forward and accounts for multi-tenant, heterogeneous topologies, where links have different latency, and where bandwidth costs and tenants have different priorities to better support cloud-scale GPU clusters. Accordingly, this disclosure presents a novel, scalable, solution to the collective communication optimization problem. It is believed to be the first multi-commodity based solution to the communication-flow problem. This new mode of thinking provides an opportunity to improve other aspects of machine-learning collectives such as topology design and failure adaptation.

Moreover, this disclosure shows how to scale the new solution to larger topologies through a linear program for ALLTOALL-like demands and a technique inspired by A* in the general case. Finally, this disclosure provides a representative evaluation of TE-CCL both on popular topologies and on proprietary, large-scale topologies from a large public cloud. TE-CCL provides better solution quality than TACCL [Ref. 1] by a factor of two in many scenarios. TACCL's heuristic is unreliable by comparison, producing different solutions in each run, and cannot find a feasible solution in many cases. In contrast, TE-CCL is reliable, produces the same solution in each run, and finds a feasible solution in instances where TACCL does not.

### 2. Motivation

Presented now is a walk-through of collective communication and a motivation for scalable communication scheduling for ML collectives. Presented next is the multi-commodity flow formulation, how it relates to collective communication optimization, and an explanation of the benefits of extending this approach to model delay, store-and-forward, and copy.

### 2.1. Fast Collective Scheduling

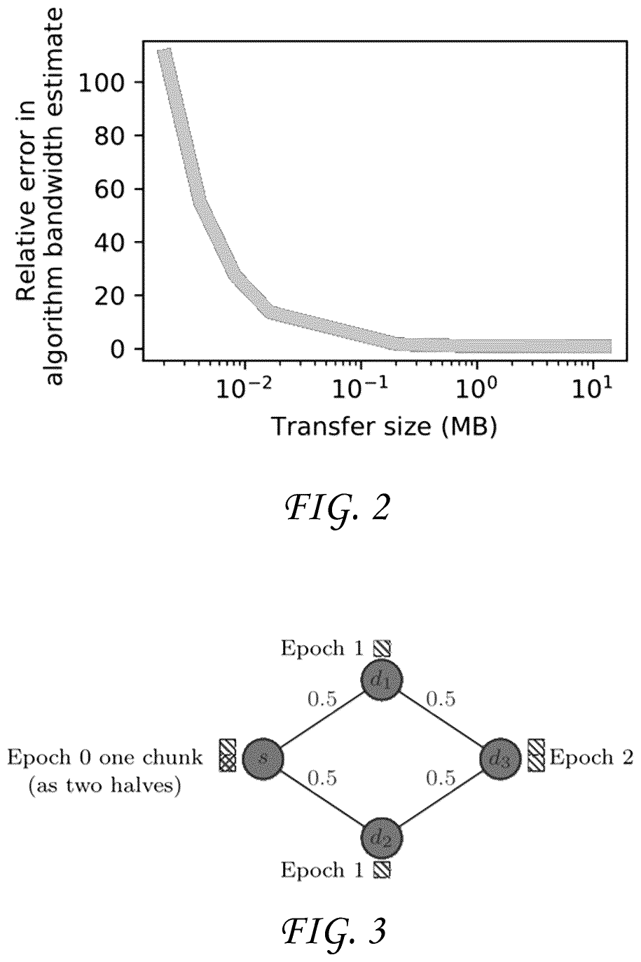

ML collectives have pronounced communication patterns with flavors of multicast aggregation trees: e.g., ALLGATHER, ALLTOALL, SCATTERGATHER. FIG. 2 in TACCL [Ref. 1] illustrates these communication patterns and how they differ. These communication patterns constitute a demand on the network where each GPU wants to send data to other GPUs. For example, in an ALLGATHER demand, each source GPU intends to send all of its data to all other GPUs, and in an ALLTOALL demand, each GPU wants to send data to all other GPUs, but the data it sends to each GPU is different. Collective communication optimizers take these demands as input and find solutions that route and schedule them efficiently to minimize transfer time. Operators use these optimizers in their multi-tenant GPU clusters and as part of solutions that help improve their offerings [Ref. 6], [Ref. 5], [Ref. 4].

Most optimizers use the α−β cost model [Ref. 19]. β is the transmission time of bytes on a link (how long it takes for the NIC to get the bytes on the wire). If one sends [symbol] bytes on a link with capacity C bytes per second, it takes [symbol] seconds for the bytes to cross that link and

$$β = \frac{1}{C} .$$

α is the constant delay of a link. In its simplest form, this feature is analogous to the propagation delay over a link but can also include factors such as the fixed compute cost of consolidating the data and making the call to the network stack to transmit the data. It takes α+βS seconds to send a chunk of size S over a link. Most existing optimizers fail to scale to large topologies (e.g., SCCL [Ref. 2]) or may produce sub-optimal schedules—e.g., NCCL [Ref. 2], [Ref. 6], and TACCL. SCCL uses SMT solvers and does not scale. TACCL separates the routing and scheduling problems and fails to co-optimize the two. The shortest-path first algorithm in [Ref. 6] fails to leverage copy.

### 2.2. Network Flow Solutions

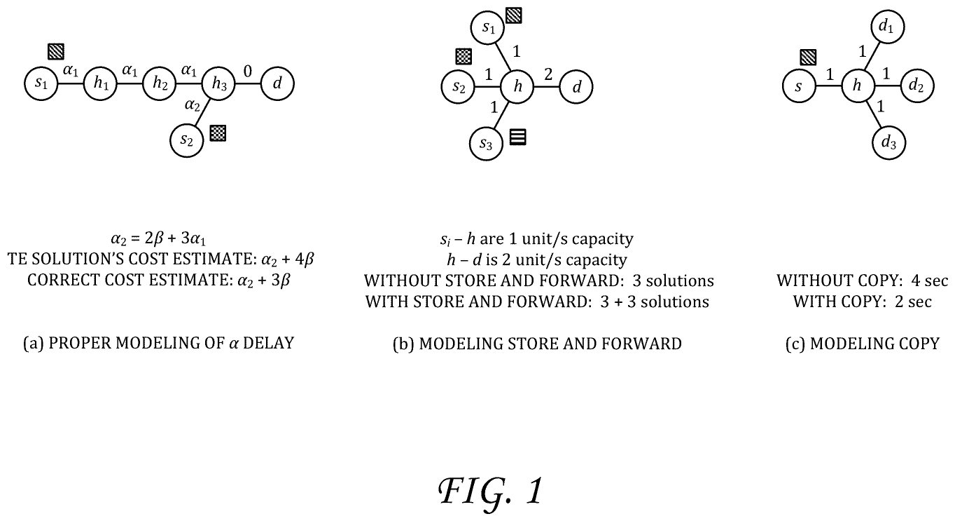

FIG. 1 illustrates, by way of example, certain advantages of proper modeling: (a) α-delay: the maximum delay across all the paths is an incorrect estimate; (b) store-and-forward: buffers improve the solver time as there are more solutions (c) copy: it is possible to leverage copy to use the available bandwidth more efficiently.

Some methods find optimal routes for wide area traffic engineering (WAN-TE) and for multicast networks (e.g., [Ref. 13], [Ref. 14], [Ref. 20], [Ref. 21], [Ref. 16], [Ref. 15], [Ref. 18], [Ref. 22], [Ref. 17]). These problems also take as input a set of demands: ‘rate requests’ between a source and a destination. The solutions aim to meet these demands and maximize the total flow that the network carries, or the network utilization, or maintain fairness without violating capacity constraints. Although these formulations take different forms—e.g., the path-formulation, which takes a set of paths as input and only allows flows to go over the input paths [Ref. 13], [Ref. 14]—they share the following features:
(a) Capacity constraints, which ensure that the traffic the solution allocates on a link never exceeds its capacity.
(b) Flow-conservation constraints, which ensure that the solution does not create traffic ‘out of thin air’ but that each non-source node forwards or consumes what it receives.
(c) An objective, which encodes what the optimization is trying to minimize or maximize—i.e., the cost model. The most common TE objectives include max-min fair rate allocations, total satisfied demand, or the link utilization.

The multi-commodity flow and the collective-communication optimization problems have several commonalities. Both take a set of demands and a topology as input and produce routes (and schedules) to optimize an objective. The two are also different, however, as the collective optimizer accounts for copy, store-and-forward, and temporal behavior (and the impact on the latency cost as a result). Each of these will now be discussed in detail.

### 2.2.1. Temporal Behavior

In the collective problem, the source wants to transfer a fixed number of bits; once the network satisfies the demand from that source, the demand goes to zero and frees up capacity. The network can then re-assign this capacity to other demands. This happens in the traditional TE as well but at larger time-scales and most deployed TE solvers periodically re-solve the optimization to handle it. This is not a problem at face-value, as the problem is soluble offline. Nevertheless, it impacts the scalability of the solution in the collective setting. Calendaring [Ref. 15] and Netstitcher [Ref. 16] both model this feature, but they do not model propagation delay and hence fail to address an important side-effect, to be described next.

### 2.2.2. Modeling Delay (the α-Cost)

Most TE solutions (e.g., [Ref. 17], [Ref. 18]) compute the delay-cost as the maximum delay across all paths where the delay of a path is the sum of the delay on each of its links. These models assume the total time needed to fulfill a demand is the transmission delay (or β-cost)+this delay-cost. With an example it can be shown why this model breaks (FIG. 1(a). Here, two sources (s₁ and s₂) want to send a unit of traffic ( [symbol] and [symbol] ) to destination d. The links on the path from s₁ to h₃ have a propagation delay α₁ and those on s₂ to h₃ have a propagation delay of α₂ where α₂=2β+3α₁. If one takes the traditional TE approach to model the delay, the path with the maximum delay is the one between S₂ and d, which has a propagation delay of α₂. It also takes an additional 4β for the traffic to get from both S₁ and S₂ to d: the TE solutions estimate α₂+4β as the completion time.

FIG. 2 shows the relative error in the algorithm bandwidth estimate (the output buffer size/transmission time) of a collective schedule that does not model alpha compared to one that does. We use a proprietary topology from a public cloud with 2 chassis, 8 GPUs, and 40 edges where the α of inter-GPU and the GPU to the switch links is 0.6 and 0.75 microseconds respectively.

However, because of the higher propagation delay on the link s₂-h₃ the data from s₁ and s₂ both arrive at h₃ at the same time (t=β+α₂). As the propagation delay on the link h₃-d is zero, the total time to complete the transfer is α₂+3β. The impact of α is greater for smaller transfers (FIG. 2); the error in the estimate of algorithm bandwidth for a schedule that does not model α to a schedule that does goes up one-hundred times.

### 2.2.3. Store-and-Forward

Most nodes in a collective topology can buffer incoming traffic before sending it out. This can be used to improve solver time (FIG. 1(b) as the number (space) of optimal solutions increases. In FIG. 1(b), without store and forward, in the first second any two nodes (3 schedules) can send their chunks to h. With store and forward, three additional schedules are available where all three sources send to h in the first second, and then the order in which to send them to the destination is chosen. The solution quality is the same for both cases; the demand is satisfied in three seconds, as confirmed by experiments in Section 5.4 across all the scenarios considered. For some collective demands store-and-forward may also help with transfer time, though it did not in the experiments here reported.

Traditional TE does not model buffering [Ref. 13], [Ref. 14]. NetStitcher [Ref. 16] models store and forward but assumes that flows do not compete for bandwidth and solves a separate optimization for each flow. These models are sub-optimal and do not scale. Some multi-cast TE solutions model intermediate caches [Ref. 18] but fail to account for the delay, and it is difficult to modify them to do so.

### 2.2.4. Copy

Some collective demands (e.g., ALLGATHER) consist of sources that send the same data to multiple destinations—i.e., multicast. Traditional TE does not model copy (e.g., SWAN and B4 [Ref. 13], [Ref. 14]) and produces sub-optimal solutions (see FIG. 1(c). Multi-cast TE [Ref. 18], [Ref. 17] addresses this problem but fails to model delay (assuming sustained demands) and, in some instances [Ref. 17], store-and-forward.

By contrast, this disclosure formulates the collective-communication optimization problem as a TE problem that supports all of the elements above. The challenge is to maintain scalability. It is shown herein that the present model, as-is, outperforms current state-of-the-art solutions such as SCCL [Ref. 2] in its ability to scale, and outperforms TACCL [Ref. 1] in solution quality. Scalability may be improved further still, as noted hereinafter.

### 3. Solution

Described next is a method to model the collective-communication problem as a multi-commodity flow problem. This solution does not scale to topologies with more than 64 GPUs. It is scaled by changing the mixed integer program (MILP) into a linear program (LP) for demands such as ALLTOALL where sources send different data to each destination and do not benefit from copy (Section 4.1), and through a more general solution called A* (Section 11).

TABLE 1
Notation. The index is enclosed in parentheses in (c)
because it is used only when demands
benefit from copy. When copy is modeled the values of F and
B are integers. For some demands (where copy is not useful)
it is possible to use real variables instead in Section 4.1.

| Variable | Description |
|---|---|
| N | Set of nodes in the graph |
| S | Set of nodes in the graph that are switches (S ⊂ N) |
| E | Set of edges in the graph (E ⊂ 2^{N×N}). Edges are |
| | unidirectional. |
| C | Chunk IDs (C = {0, 1, 2, . . . , C}). Each node |
| | has ≤ C + 1 number of chunks. |
| D | Demand function (N × C × N > {0, 1}) where D_{s,c,d} is |
| | whether destination d wants chunk with id c from node s |
| τ | Epoch duration |
| K | The set of epochs (K = {0, 1, 2, . . . , K}) |
| F_{s,i,j,k,(c)} | Amount of source s chunks that are going over link |
| | (i, j) ϵ E at epoch k ϵ K |
| B_{s,i,k,(c)} | Amount of source s chunks that are in node i's |
| | buffer at the start of epoch k |
| Tᵢⱼ | Capacity of link (i, j) ϵ E |
| αᵢⱼ | Fixed latency associated with link (i, j) ϵ E |
| δᵢⱼ | Number of epochs contained within an αᵢⱼ for each |
| | link (i, j) ϵ E |
| R_{s,d,k} | Source s chunks that node d read off of the network |
| | in epoch k |
| [symbol] _{s,d,k,(c)} | Source s chunks read off the network by d up to epoch k. |

### 3.1. The General Model

Notation is described in Table 1. Like any other multi-commodity flow problem, capacity and flow-conservation constraints and an objective are specified. To model delay, store-and-forward, and copy a few new concepts will be introduced: chunks, epochs, and buffers.

A ‘chunk’ (like a packet) is a block of bytes.¹ ‘Epochs’ are used (similar to how SCCL uses rounds) to make time discrete; epochs are fixed periods of time. The present solution produces a schedule that tells the user in which epoch they should send a chunk and on which link. Chunk sizes and epoch durations are discussed in detail in Section 4.3. For now, it will be assumed that τ is the epoch duration and Tᵢⱼ is the capacity of a link (where the units are chunks per second), and that an epoch is sufficient for at least one chunk to traverse any link. ‘Buffers’ are used to model store-and-forward. To simplify the explanation it will be assumed that each node has enough buffer capacity to store the entire network demand if desired. That assumption is removed in Section 9. To model copy, each chunk is tracked: F_{s,i,j,k,c} and B_{s,i,k,c} are used to track whether chunk c from source s is going over link (i, j) or is in node i's buffer at epoch k respectively. ¹The solution is allowed to split chunks into smaller blocks when moving to the linear-program form.

FIG. 3 provides an example of why integer variables are used to track each chunk. If partial chunks ( [symbol] and [symbol] ) were allowed and copied at the same time, then the optimization could send the same copy of part of a chunk ( [symbol] ) to two neighboring nodes (in this case d₁ and d₂) and they can forward it along to the destination (d₃). Since the formulation has no way of knowing these two halves are the same, it thinks d₃ has received the full chunk.

Integer variables are used for F_{s,i,j,k,c} and B_{s,i,k,c} to model copy; one cannot allow chunks to be split into smaller pieces. The example in FIG. 3 explains why. Source s sends the first half of a chunk ( [symbol] ) to both destinations d₁ and d₂. These nodes then both forward it to d₃: they have no way of knowing this is the same half. The optimization now thinks it has delivered the full chunk to d₃ while it has only delivered one half of it twice; it will send the second half of the chunk to both d₁ and d₂ but not to d₃. Using integers for F_{s,i,j,k,c} and B_{s,i,k,c} avoids this problem, but this is unnecessary for demands that do not benefit from copy Section 4.1. The number of chunks may be increased in order to decrease the size of each individual chunk and thereby support smaller transmission blocks (the optimization automatically consolidates them to bigger transmission units if needed). However, this also increases the number of variables and slows down the optimization.

### 3.1.1. Capacity Constraints

Capacity constraints ensure that one does not send more data than the link can carry in an epoch:

$$Capacity Constraint ( i , j , k ) {=}^{△} {\sum }_{s ∈ N} {\sum }_{c ∈ C} {F}_{s , i , j , k , c} \leq {T}_{ij} τ$$

### 3.1.2. Flow-Conservation Constraints

The purpose of these constraints is to ensure the network does not create or lose traffic. The traditional form of these constraints specifies that a node should either consume or forward all of the traffic it receives. Here the constraints are changed to account for: (a) copy, where nodes can create new traffic, and (b) delay. To model delay, a node may not forward a chunk if it has not received it. The solution first computes

$${δ}_{ij} = \frac{{α}_{ij}}{τ} ,$$

the number of epochs it takes for a chunk to traverse a link. Traffic that node i sends to node j at the beginning of epoch k arrives at node j by the end of epoch k+┌δᵢⱼ┐. Node j can forward a chunk it receives from node i if node i sent it ┌δᵢⱼ┐ ago. Copy, by definition, violates traditional flow conservation constraints: it creates traffic where it did not exist before. However, the node does not need to copy the chunk on the same link in the same epoch. This, along with δᵢⱼ, is used to rewrite the flow conservation constraints as follows:

$$Flow conservation constraints ( s , n , k , c ) {=}^{△} {B}_{s , n , k , c} + {\sum }_{∀ j \vert ( j , n ) ∈ E} {F}_{s , j , n , k - ⌈ {δ}_{j n} ⌉ , c} \geq {max}_{∀ j \vert ( n , j ) ∈ E} {F}_{s , n , j , k + 1 , c}$$

This constraint encodes that what the node n has in its buffer along with what it receives in epoch k has to be larger than what it sends out in the next epoch on each of its outgoing links. The buffer contents are tracked as follows:

$$Buffer constraints ( s , n , k , c ) {=}^{△} {B}_{s , n , k , c} = {B}_{s , n , k - 1 , c} + {\sum }_{∀ j \vert ( j , n ) ∈ E} {F}_{s , j , n , k - ⌈ {δ}_{j n} ⌉ - 1 , c}$$

The buffers accumulate all traffic the GPU has received up to that point. Nodes have enough memory for this: for collective demands such as ALLGATHER each GPU needs all the chunks that are sent over the network and stores them anyway. It is straightforward to model limited buffers as well if what should be removed from the buffer in each epoch is carefully tracked Section 9. The benefit of buffers is evaluated using an ALLGATHER demand in Section 5. The first and last epoch's flow-conservation constraints are slightly different from the above: a node does not receive anything in the first epoch and does not send anything in the last. The interested reader is referred to Section 8 for details. The following features ensure that all demands are met.

### 3.1.3. Destination Constraints

These constraints ensure each node receives its full demand by the end:

$$Destination constraints ( s , d , k , c ) {=}^{△} {ℛ}_{s , d , k , c} = min ( {D}_{s , d , c} , {B}_{s , d , k + 1 , c} ) \& {ℛ}_{s , d , K , c} = {D}_{s , d , c}$$

where [symbol] _{s,d,k,c} is whether d has received chunk c of source s by epoch k. These destination constraints are different from their counterparts in traditional TE models. This is because of copy: d may want a chunk and also relay the chunk to others. Hence, it cannot be assumed that d wants to consume everything in its buffers. This is why the minimum of D_{s,d,c} and B_{s,d,k+1,c} is taken. Further, it is ensured that d eventually receives its full demand by the last epoch K, by setting [symbol] _{s,d,k,c} to D_{s,d,c}.

### 3.1.4. Modeling Switches

So far only the behavior of GPU nodes has been modeled. While some topologies (e.g., within a single DGX1 node [Ref. 2]) only consist of GPUs, almost all larger topologies use switches to connect GPU blocks. Switches are modeled differently because they have limited memory: chunks cannot be buffered at the switch. Hence, the buffer at each switch is set to zero.

Traffic pays the α delay cost of two links to cross a switch-one from the node to the switch and one from the switch to the node. Most of today's switches support copy [Ref. 22], and so switches are modeled under that assumption, having the same flow-conservation constraint as other nodes. However, it is also possible to model switches without this capability, to support legacy hardware. One way is to replace the flow conservation constraints at the switch with the traditional TE flow conservation constraints; what comes into the switch must go out.

Another option is to use the approach from TACCL [Ref. 1]: replace switches with hyper-edges and allow the user to choose which hyper-edges to allow. For this second model additional constraints are added (Section 10). The former two approaches are easier to use in practice. There the operator does not need to specify a sketch (which is a done in TACCL) or to pick which GPU communicates with which other GPU. One must understand the topologies well to write such sketches, which may be difficult in TACCL. In contrast, the solution herein requires no human in the loop; the operator only specifies the topology and the demand matrix.

### 3.1.5. Example Objective

While other objectives lie fully within the metes and bounds of this disclosure, one example optimization objective is to finish the transfer as quickly as possible:

$$Objective function {=}^{△} {\sum }_{∀ k ∈ K , ∀ s , d ∈ N : s \neq d} \frac{1}{k + 1} {ℛ}_{s , d , k}$$

Notice how the objective gives fewer rewards as k increases: the objective improves if the schedule satisfies the demand as soon as possible. If the objectives and the above constraints are combined, an optimization that maximizes the objective subject to all of the above constraints is achieved. One nuance here is that the optimization has multiple optima: the objective does not discourage solutions where we send flows that do not satisfy any demand (as long as the schedule satisfies all demands as quickly as possible the solution is optimal). Such solutions are clearly wasteful. To avoid such cases, it is possible to (a) add a term to the objective to discourage unnecessary flows; or (b) zero out those flows by post-processing the solutions. The first results in higher solver run times as it becomes harder for the solver to prove optimality. The latter approach may be used when running an algorithm similar to a reverse DFS. The algorithm starts from each destination, and tracks the flows from that destination to the source until the entire demand is accounted for. Then all remaining flows are zeroed out, as there is no demand corresponding to them. This takes [symbol] (|N|+|E|) time where N is the number of nodes in the graph and E is the number of edges.

### 4. Scaling

This formulation is general and pushes beyond the scale boundaries of SCCL and outperforms the solution quality of TACCL, but it is slow for topologies with more than 32 chassis. Shown next are two methods to scale this solution. The first works in situations where copy is not useful (e.g., ALLTOALL) and preserves optimality. The second is general (i.e., supports copy); it solves the problem by partitioning it in time. The goal, in each time partition, is to make as much progress as possible towards finishing the transfer. The later model is sub-optimal but outperforms the TACCL heuristic Section 5, as it more accurately captures the optimization incentives and constraints. Its formulation allows operators to trade optimality for speed by changing the number of partitions, smaller partitions reducing optimality but improving scalability.

### 4.1. Scaling by Converting to a Linear Program

Integer variables are used in the model to accommodate copy, but some demands do not benefit from copy, such as when each destination wants a unique segment of information from each source. In these scenarios the formulation may be changed into a linear program (LP). LPs are convex optimization programs which it is possible to solve in polynomial time and scale much better than MILPs.

Support for copy is removed, therefore, and the flow-conservation constraints modified back to their traditional form. The following constraint dictates that a node either buffers a chunk it has received, forwards it in the next epoch, or consumes it. Notice that a node can consume a chunk it received at the end of an epoch. Individual chunks are not tracked since there is no concern about duplicates. This reduces the number of variables.

$$Flow comservation constraints ( s , n , k ) {=}^{△} {\sum }_{\{ j \vert ( j , n ) ∈ E \}} {F}_{s , j , n , k - ⌈ {δ}_{j n} ⌉} + {B}_{s , n , k} = {B}_{s , n , k + 1} + {R}_{s , n , k} + {\sum }_{\{ j \vert ( n , j ) ∈ E \}} {F}_{s , n , j , k + 1}$$

The flow conservation constraints for switches are different: a switch does not consume chunks and does not buffer them. Accordingly, those terms are removed from the flow conservation equations. Since destinations no longer need to both consume and forward chunks, it is possible to modify the destination constraints:

$$Destination constraints ( s , d , k ) {=}^{△} {ℛ}_{s , d , k} = {\sum }_{r = 0}^{k} {R}_{s , d , r} \& {ℛ}_{s , d , K} = {\sum }_{∀ c} {D}_{s , d , c}$$

LP produces a rate allocation to demands that originate from each source on each link. From this is generated a schedule that is executable in hardware: the rates are translated into paths for each chunk through the same DFS, like the solution described earlier. This is a straightforward algorithm. TE solutions may use similar algorithms [Ref. 15], [Ref. 16].

### 4.2. Scaling Using the A* Technique

The LP form allows the solution to be scaled to large topologies but does not permit copy. Copy is important for demands such as ALLGATHER (see Section 2). Thus a second scaling method is provided.

The problem is partitioned into multiple rounds. It is no longer an objective in each round to find a solution that satisfies all demands, but instead to motivate the solver to make as much progress towards the goal as it can. These optimizations have fewer variables and are faster. They are solved sequentially, one after another, until a round where all demands are met is reached. Two new modeling challenges are addressed next.

### 4.2.1. Encoding the Right Incentives

It is necessary to remove the constraint that required the optimization to meet all demands by the last epoch; otherwise the optimization in each round may become infeasible. This means that the objective function is no longer sufficient; it only says that if it is feasible to satisfy a demand then do so as fast as possible, but it does not reward incremental progress. Accordingly, the objective may be modified to include a term that rewards the optimization for moving data closer to the destinations in each round. But how to do this in a way that preserves the MILP format?

The topology is augmented with logical links that allow computation of the reward function: logical edges are added to the graph that connect each node to all the destinations, and weights are added to each of these logical edges that correspond to the minimum distance. The weights are computed using the Floyd Warshall algorithm [Ref. 23], and the α-delay cost of each edge from the node to each destination is also computed. These edges may now be used to encode a viable cost function which it is possible to add to the original objective Section 11.

### 4.2.2. Modeling Delay

Chunks sent on any link (i, j) may not reach j by the end of the round (because of the αᵢⱼ-delay on that link) but instead may arrive in a future round. Therefore the state from one round to the next is maintained and the late arrivals are incorporated into the formulation. The interested reader is referred to the appendix.

### 4.3. Considerations

Methods for collective-communication optimization using a TE approach are described hereinabove. All three formulations (the general MILP form, the LP form, and A*) find solutions for any input demand but only the general MILP form and the A* model support copy.

### 4.3.1. Epoch Durations and Chunk Sizes

A side-effect of using integer variables in the MILP formulation and the A*based technique is that the choice of chunk-size and epoch duration is important (the LP is not sensitive to these settings): smaller epochs allow for finer-grained schedules that better leverage the available network capacity. To find the best chunk size it is possible to sweep a range of values to find the best one quickly. This can also be taken as an input: smaller chunks allow for finer grained schedules but can increase the resource usage on a node. Operators can also utilize solutions such as [Ref. 5] to pick what is optimum for their work-flow.

To set the epoch duration it is possible to do one of two things: (a) to get the best schedule from the vanilla MILP formulation, it is possible to set the epoch duration to the time it takes the slowest link to transmit a chunk. The MILP cannot send anything if smaller epochs are used because of the capacity constraints; (b) it is possible to set the epoch duration based on the time it takes the fastest link to transmit a chunk. Option (b) enables the MILP to produce finer grained schedules but to use it the capacity constraints and the flow-conservation constraints are modified: the capacity constraints ensure that one does not exceed the capacity on the slowest link; the flow-conservation constraints ensure that one does not forward a chunk before receiving it Section 13. The two options are compared in Section 5. Option (b) produces better schedules, so it is used for most of the evaluations herein.

### 4.3.2. Number of Epochs

It is helpful to input an upper bound on the number of epochs, which estimates how many epochs it may take to fully satisfy the demand. Pick too small a number and the optimization will be infeasible; pick too large of a number and the MILP will be too large and too slow. To streamline finding the right number of epochs—and not burden the user with having to identify what numbers to use—an algorithm is developed which finds a loose upper bound on how long it may take to satisfy all the demands.

To find this number, the method sweeps a range of transmission times: for each transmission time, coarser-grained epoch durations (very large epochs) are used for the optimization. Because such large epoch sizes are used, there are fewer variables, which allows the optimization to be solved quickly. The solution of these runs is not optimal (because the epochs are too coarse), but gives an estimate of the time need under optimal epoch duration in Section 12. The output is used to initialize the optimization, which automatically identifies whether a lower number of epochs is sufficient.

### 4.3.3. Number of Epochs in a Round in A*

Round after round of A* is solved, until all the demands are delivered. Operators can choose how many epochs to use in each round. The smaller the number of epochs in a round, the faster the optimization and the higher the optimality gap. Picking a small number of epochs per round also impacts the state that can be maintained. In experiments the number of epochs was set such that chunks do not arrive later than one round in the future.

### 4.3.4. The Topology, α, and β Inputs

TE-CCL takes the topology and the values for α and β as input. No independent method is provided for computing these values.

### 4.3.5. Which Switch Model to Use

Two switch models are provided: one that allows the switch to copy chunks (to model networks with the SHArP protocol [Ref. 22] enabled), and one that does not. It is up to the operator to decide which model to use in the optimizer.

### 4.3.6. Modeling Variable Bandwidth

The model supports networks with variable bandwidth. To add support for this, it is assumed that bandwidth only changes from one epoch to the next. The capacity matrix for each epoch is then taken and used in the capacity constraints.

### 4.3.7. Use in Multi-Tenant Clusters

TE-CCL supports multi-tenant communication optimization: all models accept a network demand as input. To model a multi-tenant environment the demand matrix is changed to the sum of the demands across all collectives. The capacity constraints will ensure that the network capacity is not exceeded, and the objective ensures that the total completion time across all tenants is minimized.

It is possible also to support priorities across tenants (i.e., prioritizing one tenant's completion time over the others) by adding a separate buffer and read variable for each tenant; it is possible to then add the priorities to the objective function. This change increases the number of variables in the MILP which slow it down. A* may be used in this case, which would not impact the quality of the solution compared to solution of a single tenant problem at the same scale.

### 4.3.8. Scaling Through Intermediate Solutions

The solver in use, Gurobi [Ref. 24], often finds an optimal solution and then spends a long time proving that it is optimal. Sometimes the solution does not improve even after the solver runs for an additional ten hours. A timeout is applied, therefore, so that the solver may be stopped after 2 hours to return the solution found at that point. Gurobi reports its progress through the primal-dual gap [Ref. 25].

### 5. Evaluation

The solutions herein have been implemented in Python. Gurobi [Ref. 24] is used to solve the optimizations. The solutions are converted into MSCCL [Ref. 2], which return a schedule that runs on appropriate hardware. The goal in this evaluation is to: (a) compare TE-CCL to state-of-the art, both in scale and in terms of solution quality; (b) show that TE-CCL scales to large topologies; and (c) show the impact of each of the different design choices.

### 5.1. Metrics

The following metrics are used to evaluate TE-CCL.

### 5.1.1. Solver Time

The solver time is the time it takes to solve the collective optimization problem, including time to set up the variables and constraints in the solver.

### 5.1.2. Transfer Time

The transfer time is the time it takes for the transfer to complete—i.e., for all the nodes to receive their full demand.

### 5.1.3. Output Buffer Size

The output buffer size is the data each GPU receives once the demand is satisfied.

TABLE 2
Topologies.
The internal topologies are from a large public
cloud and are proprietary: α is 0.6 μs and 0.75 μs
on their GPU to GPU and GPU to switch links.

| | # of GPUs | # of edges |
|---|---|---|
| Topology | per chassis | per chassis |
| Internal 1 | 4 | 8 |
| Internal 2 | 2 | 2 |
| DGX1 | 8 | 32 |
| NDv2 | 8 | 32 |
| DGX2 | 17 | 32 |

### 5.1.4. Transfer Size

The transfer size is the amount of data each GPU sends to others. For example, a GPU in an ALLGATHER demand with a transfer size of 1 GB sends 1 GB of data to every other GPU.

### 5.1.5. Algorithmic Bandwidth

The algorithmic bandwidth is the output buffer size divided by the transfer time.

### 5.1.6. Topologies and Workloads

TE-CCL is evaluated using the topologies in Table 2. Common topologies such as DGX1, DGX2 [Ref. 26], and NDv2 [Ref. 9] are used, as well as two proprietary topologies from a public cloud provider.

### 5.1.7. TE-CCL Variants

Three variants of TE-CCL are used in evaluations: the optimal (where the vanilla MILP for ALLGATHER and LP for ALLTOALL), the early-stop version for ALLGATHER (where Gurobi's ability to find a good solution is used (which is at most 30% away from optimal), and A* for ALLGATHER.

Gurobi runs into numerical issues with ALLTOALL on large topologies (more than 64 nodes); it is helpful to run it with a different configuration (method=2 [Ref. 27]) which causes it to produce a feasible (but not optimal) solution. In those cases, the solver is run in a loop and a binary search is done on the number of epochs to find the optimal solution. The epoch duration is set based on the bandwidth of the fastest link. In the cases where α>200×τ the epoch duration is increased by 5× to avoid large models. Since a dominates, this does not materially impact the solution. TE-CCL solves optimization problems to produce a schedule, and the optimization is deterministic, outputting the same number of epochs to meet the demand every time it is run. The solver times also do not vary significantly for a given optimization across runs.

### 5.1.8. Baselines

TE-CCL was compared to two state-of-the-art solutions: TACCL [Ref. 1] and SCCL [Ref. 2].

The TACCL code was obtained from the authors, and the solver time was tracked and reported. TE-CCL takes an additional β compared to TACCL to route chunks through a switch: TACCL replaces the switch with direct edges between the nodes and only pays one transmission delay to cross that link whereas TE-CCL models the switch itself and pays two transmission delays—one from the node to the switch and one from the switch to the node. In order to compare fairly, the switch model in TE-CCL was modified to do the same in comparisons against TACCL.

SCCL was compared using the public SCCL code-base [Ref. 28] and experiments were re-run using the SCCL artifact from the authors' submission.

### 5.1.9. Platform

The solvers and the schedules they produce were used to compute the transfer times and algorithmic bandwidth for SCCL, TACCL, and TE-CCL. Using a single 8-GPU DGX1 node these estimates were checked against results from running on

TABLE 3
Comparing the transfer time from SCCL least-steps with
TE-CCL (K = 10 and chunk size = 25 KB).
TE-CCL can better pipeline chunks
and so pays less α cost with larger transfers.

| Collective, # chunks | SCCL (μs) | TE-CCL (μs) |
|---|---|---|
| ALLGATHER, 1 | 3.4 | 4 |
| ALLGATHER, 2 | 5.1 | 5 |
| ALLGATHER, 3 | 8 | 6.1 |
| ALLTOALL, 1 | 3.4 | 4 |

hardware for both TE-CCL and TACCL.

### 5.1.10. Unexplored Avenues

It is shown from testing on a DGX1 that TE-CCL's estimates of collective latency match the actual runtimes on prototype hardware. However, the effect of factors such as congestion, message batch sizes and other GPU implementation artifacts on the collective latency remains an unknown. Results on all of the other metrics such as solver times and the ability to scale to large topologies hold regardless.

### 5.2. Comparison to SCCL and TACCL

SCCL has two modes: one minimizes latency (least-steps) and one produces an instance solution (instance) with the number of chunks, rounds, and steps as input. Here the disclosed solution is equivalent to the former but the SCCL least-steps command took over a day to produce a solution for ALLGATHER demands with more than 3 chunks and ALLTOALL demands with more than 1 chunk on a DGX1 topology. The SCCL paper does not evaluate this mode. In contrast, TE-CCL was run with max K=K=10 (the maximum number of epochs the optimization can use to satisfy the demand) and 25 KB chunks, and it finished in ≤0.65 s for all ALLGATHER demands and ≤0.97 s for ALLTOALL demands with less than 5 chunks.

25 KB chunks were used to capture the impact of α (α=0.7 μs) on the solutions (Table 3): for all >1 chunk cases TE-CCL outperforms SCCL as it models the α delay better. It ensures that a node receives a chunk before forwarding it but pipelines traffic. SCCL enforces a barrier instead. SCCL performs better in the 1 chunk case as TE-CCL cannot leverage its ability to pipeline.

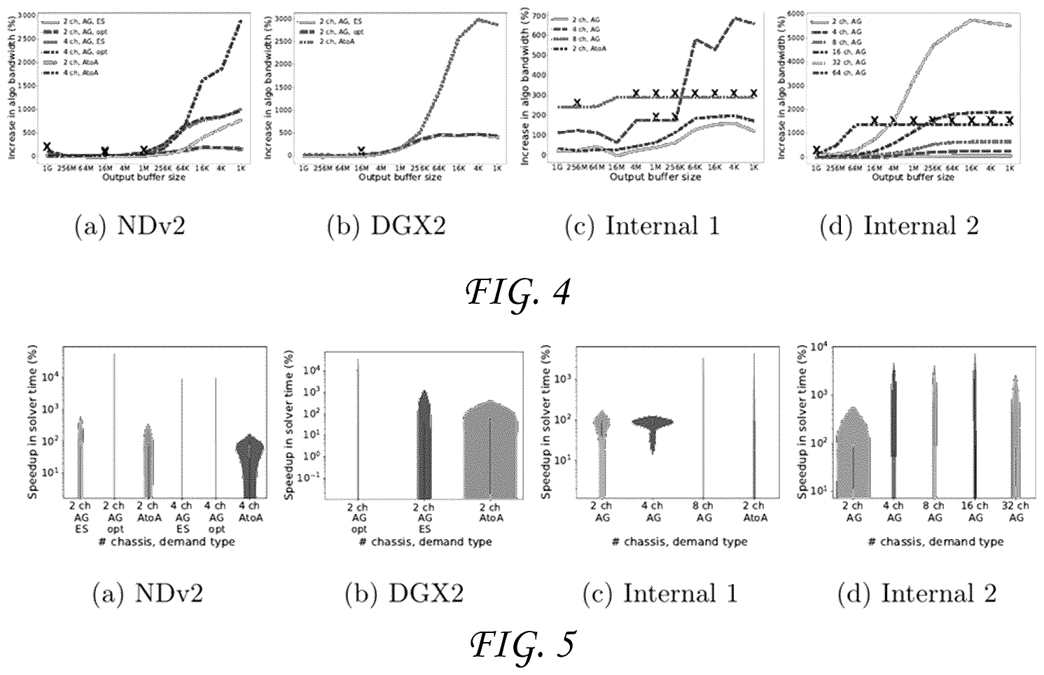

FIG. 4 compares the algorithmic bandwidth of TE-CCL and TACCL (100(TECCL−TACCL)/TACCL). The scenarios were marked where TACCL is infeasible—which cause dips in the graph—using an X. FIG. 5 compares the solver time of TE-CCL and TACCL (100(TECCL−TACCL)/TACCL). Ch stands for chassis, ES early stop, AG ALLGATHER, and AtoA ALLTOALL. Log scale was used for the y-axis to improve resolution. TE-CCL is faster than TACCL on 45% of ALLTOALL scenarios and 40% of ALLGATHER scenarios (with early stop) on the NDv2 topology; 72% and 27% for DGX2; 72% and 83% for Internal 1; and 100% and 50% for Internal 2.

Comparison with SCCL's instance solution was also made, as shown hereinafter. To create an apples-to-apples comparison, the number of rounds was used in SCCL for K in TE-CCL, since SCCL is no longer running an optimization, and so α=0 is used. This is necessary as TE-CCL will need more epochs otherwise to account for a). The scenarios from Table 4 were used in SCCL [Ref. 2] and both solvers were run on a desktop with 6 cores and 32 GB RAM. SCCL failed to produce a solution for ALLGATHER workloads with more than 1 chunk even after 3 days. TE-CCL runs faster than SCCL in almost all cases and even improves SCCL's solution quality by 33% in the ALLTOALL scenario. TE-CCL is slower than SCCL in one instance ((6, 7)): this is because in TE-CCL the optimal number of epochs is solved for, and a value for K is used which is too tight. It is possible to reduce the solver time to 11 seconds by increasing K to 20, and the quality of the solution does not change). The A* technique may be used to speed up the solution further. To fully highlight the runtime advantage over SCCL, an ALLTOALL demand with 8 chunks using both solvers was run: SCCL timed out after 10032.7 s and did not produce a schedule, whereas TE-CCL finished in 1.88 s with a valid schedule that finished the transfer in 21 μs (for 25 KB chunks).

The solver time and algorithmic bandwidth of TE-CCL and TACCL were compared using ALLGATHER and ALLTOALL demands and on DGX2 and NDv2 based topologies with up to 34 nodes (a 2-chassis DGX2 topology has 34 nodes) and on both internal topologies with up to 128 nodes. All experiments were run on a Linux Ubuntu 20.04 VM with two Intel Xeon® Platinum 8380 CPUs with a total of 80-cores/160-threads and 512 GB RAM and used Gurobi 9.5.2 version as the solver. TACCL ALLTOALL does not terminate for large topologies (including the 2 chassis DGX2 ALLTOALL). A timeout of 2+2 hrs or 4+4 hrs was used for their routing and scheduling phases depending on the topology size. TACCL ran out of memory and did not produce a solution for large Internal 2 topologies (with over 64 chassis) and for almost all Internal 1 topologies (with over 4 chassis). Table 4 reports the numbers for TE-CCL on ≥64 nodes topologies.

TACCL scales better on the NDv2 topology compared to internal topologies 1 and 2. In NDv2 only two nodes in a chassis connect to a switch but in internal topologies 1 and 2, many nodes in a chassis are connected to a switch. TACCL replaces the switch with direct edges; as the size of internal topologies 1 and 2 is increased the number of such edges increases exponentially. The TACCL authors recommended a sketch that only uses a subset of these edges. Doing so improved the runtime for smaller topologies but TACCL still failed to produce a solution after 8 hours for larger ones.

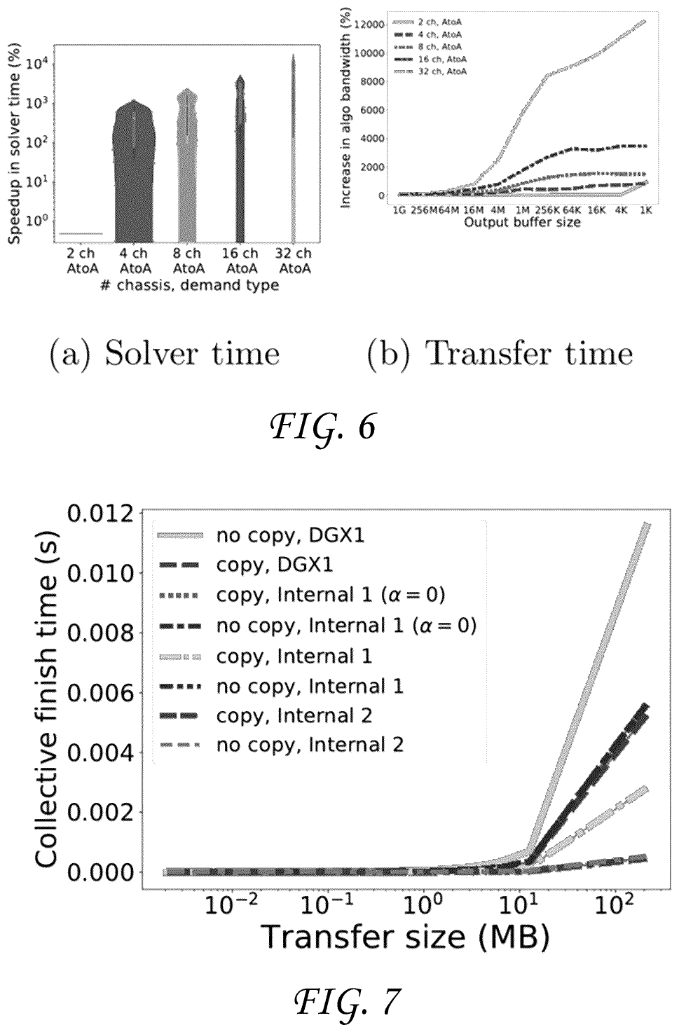

TE-CCL often produces higher quality solutions compared to TACCL (in some cases TACCL fails to produce a schedule and times out). On DGX2 the improvement is at least 12% and 9% (maximum 471% and 2979%) for ALLGATHER and ALLTOALL respectively; on NDv2 0.36% and 0.18% (maximum 970% and 2919%); on Internal 1-5% and 20% (maximum 689% and 197%), and on Internal 2, 0.33% and 0.48% (maximum 5759% and 12322%). These results are shown in FIG. 4 and FIG. 6 (ALLTOALL numbers for Internal 2 separately are reported for clarity).

FIG. 6 provides two plots comparing TACCL and TE-CCL for ALLTOALL demands on Internal 2 with different number of chassis. TE-CCL is faster than TACCL in all cases and also produces higher quality solutions.

Gurobi's early-stop for ALLGATHER demands are used to improve TE-CCL's ability to scale; this does not materially impact the quality of TE-CCL's solution—even with an aggressive optimality gap threshold of 30%—but allows TE-CCL to solve the problem faster in the ALLGATHER scenario. TACCL also uses this under the hood, and the TE-CCL solver time matches TACCL even when TACCL uses this feature. TACCL uses the early stop mechanism in the ALLTOALL case as well but TE-CCL is run to completion. TE-CCL always produces schedules that match or beat those of TACCL and in many cases it produces these schedules more quickly. The two solver times are compared in FIG. 5.

### 5.3. Scale

TACCL often crashes on large topologies, either due to requiring more than 400 GB RAM or memory leaks and segmentation faults. TE-CCL also requires a lot of memory in some cases (around 350 GB for ALLTOALL on large topologies), but it is possible to control this by changing the epoch duration to trade off the quality of the solution with the amount of memory the solver needs. Table 4 summarizes the results on large topologies and reports the scale factor (EM). Output buffer sizes larger than 16 MB are used. As the number of GPUs increases, chunks become too small beyond this point. The epoch size is adjusted by a factor of, at most, 4 for these cases to limit memory usage.

### 5.4. Microbenchmarks

Evaluated next are certain features:

### 5.4.1. Copy

In-network copy is most helpful for large transfers where there is not enough capacity to transfer multiple copies directly from the source to each destination. In the largest transfer size (0.21 GB) copy reduces the transfer time by 50% for DGX1, the Internal 1 with α=0 and α>0, and 12.5% for Internal 2. In-network copy does

TABLE 4
Large Topologies for which TACCL cannot synthesize
the schedule. The solver time is the average TE-CCL
time to synthesize the schedule and EM is the
epoch multiplier factor to change the epoch duration
from the optimal duration for scalability.

| Topology | Collective | # GPUs | EM | Solver time | |
|---|---|---|---|---|---|
| Internal 1 | AG (A*) | 64 | 1 | 3000 | s |
| Internal 1 | AG (A*) | 128 | 1 | 7 | h |
| Internal 2 | AG (A*) | 128 | 1 | 1300 | s |
| Internal 2 | AG (A*) | 256 | 2 | 2.8 | h |
| Internal 1 | AtoA | 16 | 1 | 66 | s |
| Internal 1 | AtoA | 32 | 1 | 215 | s |
| Internal 1 | AtoA | 64 | 1 | 500 | s |
| Internal 1 | AtoA | 128 | 2 | 800 | s |
| Internal 2 | AtoA | 128 | 1 | 2600 | s |
| Internal 2 | AtoA | 256 | 4 | 1500 | s |

not help with small transfers as there is enough capacity between the source and the destinations to send multiple copies of the data directly from the source. Four chunks are used to complete these transfers.

FIG. 7 illustrates the benefit of copy: for large transfers, copy helps finish the transfer faster.

### 5.4.2. Small Versus Large Epochs

This disclosure investigates how the duration of epochs impacts the solver speed and the quality of the solution (FIG. 8 where two chassis are used for each topology). In ALLGATHER chunks are only allowed to traverse one link in a single epoch: the length of the longest path dominates the transfer time when large epochs are used because the length of the epoch is too large compared to how long it takes for the chunk actually to traverse the link (on faster links). This is seen more predominantly in the NDv2 and DGX2 topology where the fast links have four times higher bandwidth (large epoch duration is, therefore, four times the small epoch duration) compared to slower ones. In contrast, no difference is seen on Internal 1, where the links are mostly homogeneous.

FIG. 8 shows the impact of small versus large epochs on the solver speed (a) and solution quality (b) are compared. Two chassis are used for all topologies. Both graphs compute 100(small−large)/large. The solver finds a solution faster with large epochs but produces better quality solutions with small ones.

### 5.4.3. Store and Forward

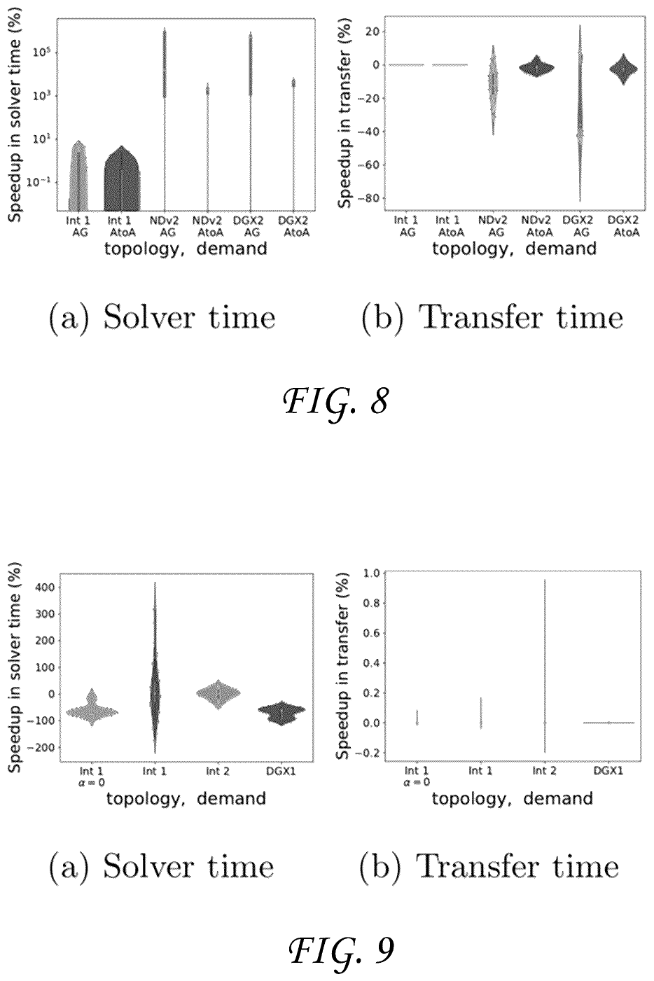

In this case a somewhat surprising result is found. Buffers do not impact the solution quality but only the solver time (FIG. 9). This is because of the nature of collective demands such as ALLGATHER and ALLTOALL. Because each node needs the same amount of traffic as it has to forward it can interleave consuming traffic with forwarding it to compensate for the lack of buffers. But in the presence of buffers the feasible space of solutions is larger which in many cases enables the solver to find the optimal solution more quickly (the speedup is 71% and 61% for Internal 1 and DGX1 respectively). It is believed possible to formally prove this result.

FIG. 9 shows the impact of buffers on (a) solver time and (b) solution quality is evaluated. Two chassis are used for all topologies. Both graphs compute 100(with buffers−without buffers)/without buffers. Buffers do not impact the solution quality but only the solver times. The average speedups in solver time are: −61%, 28.46%, −0.23%, −71% for Internal 1 without α, Internal 1 with α, Internal 2, and DGX1 respectively.

### 5.4.4. A* Versus OPT

The quality of the A* technique to the optimal on a 16-chassis Internal 2 topology is compared with both α>0 and α=0. Both single chunk and 2 chunk transfers were used. When α=0, A* finished in 86.61 s (263.29 s for 2 chunk demands) whereas the optimal took 346 s (4392 s for two chunks). The optimal solution was 10% better than A* (6% in the 2 chunk case). Transfer times were 3.48 s versus 3.89 s. The results are similar when α>0: A* finished in 137.02 s (901.25 s for the 2 chunk case) whereas the optimal took 363.40 s (3047 s). The optimal solution was 20% better (8% in the 2 chunk case).

### 6. Related Work

TE-CCL provides a scalable method for collective communication optimization via a network flow-based approach. This solution supports unsustained demands, store-and-forward, and copy. Prior work has explored traffic engineering for multi-cast networks [Ref. 18], [Ref. 17]. Oliveira and Pardalos [Ref. 29] provide a comprehensive summary. Blink [Ref. 3] used such techniques to optimize collective communication but did not model delay and store-and-forward.

Prior networking approaches use the network-flow model to scalably route traffic in wide-area networks [Ref. 13], [Ref. 14], [Ref. 20], [Ref. 21]. However, most of that effort assumes sustained demands, copy, and store-and-forward. Within this work, Calendaring [Ref. 15] provides a solution that models unsustained demands. NetStitcher [Ref. 16] adds to this the support for store and forward but assumes that flows do not compete for bandwidth. Neither approach simultaneously models copy, store-and-forward, and delay.

Prior work has explored the collective-communication optimization problem [Ref. 2], [Ref. 1], [Ref. 3], [Ref. 6], [Ref. 30]. These solutions do not scale to the topologies and data sizes in use today or anticipated for the future. TACCL is the most scalable of the prior solutions but has trouble scaling when sending more than one or two chunks and is sub-optimal. Work such as [Ref. 5], [Ref. 4], [Ref. 6] aims to co-optimize either topologies and parallelization strategies ([Ref. 4]) or collective scheduling and execution planning [Ref. 5]. These approaches rely on collective-communication optimizers as part of their search but do not provide optimal solutions to the problem themselves.

### 7. Additional Disclosure, References, and Conclusion

This disclosure presents TE-CCL: a scalable collective communication optimizer that models the schedule-optimization problem via a TE-based approach. Three algorithms are provided to solve this problem: the MILP method which optimally solves the general collective communication optimization problem and supports multi-cast; the LP method which is also optimal and much more scalable but removes support for multi-cast; and finally the A*-based approximation method which is much more scalable than the MILP technique and continues to support multi-cast, but is no longer optimal. The solutions herein outperform state-of-the-art SCCL and TACCL by a factor of two or greater.

Supported by example in the sections above and in the appendices further below, the following additional disclosure reprises more compactly the technical solutions herein.

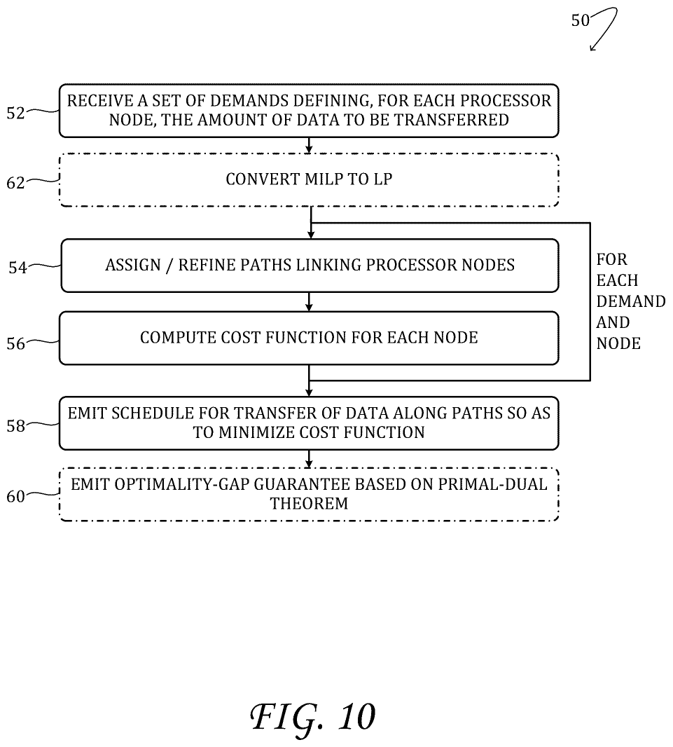

FIG. 10 shows aspects of an example method 50 for scheduling a coordinated transfer of data among a plurality of processor nodes on a network. In some examples each of the plurality of processor nodes comprises a graphics processing unit (GPU). In some examples the model is further configured represent a plurality of switches configured to connect different blocks of GPUs on the network. In other examples, each of the plurality of processor nodes may comprise a central processing unit (CPU), or any other type of processor. In method 50 a multi-commodity flow model is operated subject to a plurality of predetermined constraints. In some examples the plurality of predetermined constraints include, for each processor node, a capacity constraint, a flow-conservation constraint, and a destination constraint. In more particular examples the flow-conservation constraint may include a buffer constraint. More particularly, the multi-commodity flow model is configured to enact the various steps of method 50.

At 52 of method 50 the multi-commodity flow model receives a set of demands as input. The set of demands define, for each of the plurality of processor nodes, an amount of data to be transferred. This feature stands in contrast to other TE applications, where each demand is typically expressed in terms of a data-transfer rate—e.g., a bit rate. The nature of the data is not particularly limited in method 50. In some examples the data includes a plurality of weighting factors of a machine-learning model. Optionally the weighting factors may be computed by the plurality of processor nodes themselves.

In some examples the set of demands received at 52 may comprise an ALLTOALL demand, an ALLGATHER demand, and/or an ALLREDUCE demand. In some examples the set of demands may comprise a sum of demands across a plurality of collectives in a multi-tenant cluster on the network. In some examples, fairness or neutrality among tenants is incentivized in the cost function (vide infra) used in the optimization. In other examples and scenarios, the multi-tenant cluster may service the demands of first and second tenants, and the cost function is adapted to prioritize the demands of the first tenant over the demands of the second tenant.

At 54 the multi-commodity flow model assigns a plurality of paths (e.g., routes) linking the plurality of processor nodes. At 56 the multi-commodity flow model, iterating over each demand and each processor node, computes the predetermined cost function for the data transfer represented in the set of demands. In some examples the predetermined cost function comprises a length of time for completion of the coordinated transfer of data. Alternatively or in addition, the predetermined cost function may comprise a metric of processor disuse.

In some examples the cost function is minimized in dependence on a data-transfer latency for each of the plurality of processor nodes. In some examples at least two of the plurality of processors have different data-transfer latency, and the cost function reflects that feature. More generally, the network may comprise a heterogeneous topology of links, where at least two different links in the topology have different latency. In some examples the cost function may be adapted to discourage unnecessary data transfer during operation of the model. In some examples the multi-commodity flow model is configured to operate within successive partitions of time, and minimizing the cost function includes maximizing progress toward completion of the coordinated transfer of data within a current partition.

At each step of the optimization, method 50 returns to 54, where the plurality of paths and scheduling parameters thereof are subject to refinement so as to minimize the cost function. The process is repeated until the paths and scheduling parameters converge to a schedule for transfer of the data along the plurality of paths, so as to minimize a predetermined cost function. Then, at 58 the multi-commodity flow model emits the schedule.

In method 50 the emitted schedule comprises at least one store-and-forward operation and at least one copy operation. In some examples where the processor nodes comprise GPUs, the store-and-forward operation and the copy operation may each employ cache memory of the plurality of GPUs. In more particular examples the copy operation may support multicasting to two or more of the plurality of GPUs. At optional step 60 the multi-commodity flow model emits an optimality-gap guarantee for the schedule based on the primal-dual theorem.

In some examples the multi-commodity flow model may be formulated as a mixed-integer linear program (MILP), which can be executed on suitable server-side hardware with adequate speed, so as to avoid excessive latency for the resource allocation. A further increase in allocation speed and reduction in latency may be achievable, however, by converting the MILP into a linear program (LP). Method 50 includes, accordingly, an optional step 62 where the MILP is converted into an LP. In some examples the conversion process may comprise removing certain integer variables from the MILP. In more particular examples all of the integer variables are removed.

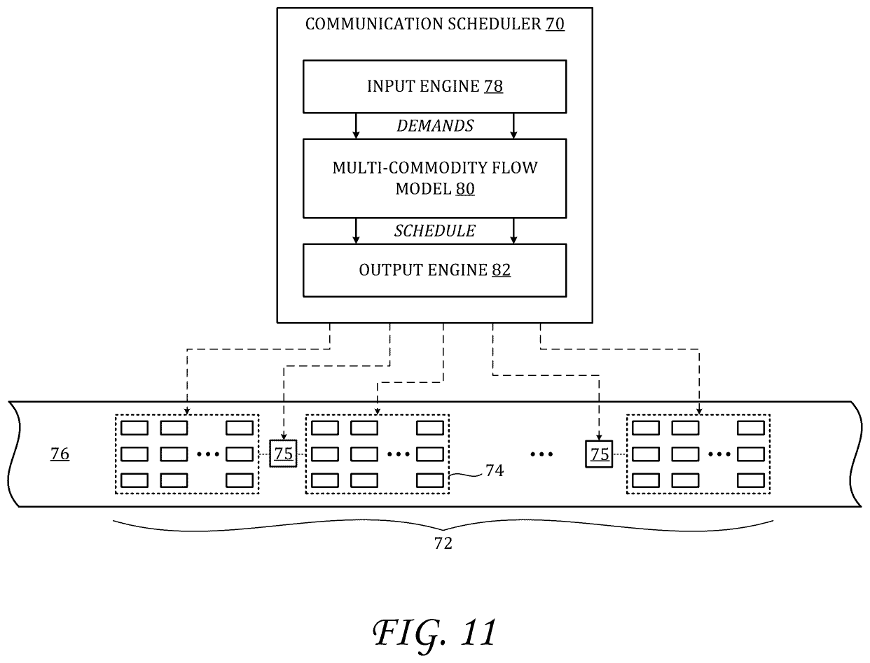

FIG. 11 shows aspects of an example communication scheduler 70 for an ML collective 72 of a plurality of GPU clusters 74 and switches 75 arranged on a network 76. The communication scheduler comprises an input engine 78, a multi-commodity flow model 80, and an output engine 82.

Input engine 78 of communication scheduler 70 is configured to furnish a set of demands defining, for each of the plurality of GPUs 84, an amount of data to be transferred to that GPU. Multi-commodity flow model 80 is formulated to operate within a plurality of predetermined constraints and configured to execute any, some, or all of the methods defined in the context of FIG. 10. In particular, the multi-commodity flow model is configured to (a) receive the set of demands as input from the input engine, (b) assign a plurality of paths linking the plurality of GPUs, and (c) emit a schedule for transfer of the data along the plurality of paths so as to minimize a predetermined cost function, wherein the schedule comprises at least one store-and-forward operation and at least one copy operation. Output engine 82 is configured to output the schedule, together with an optimality-gap guarantee for the schedule.

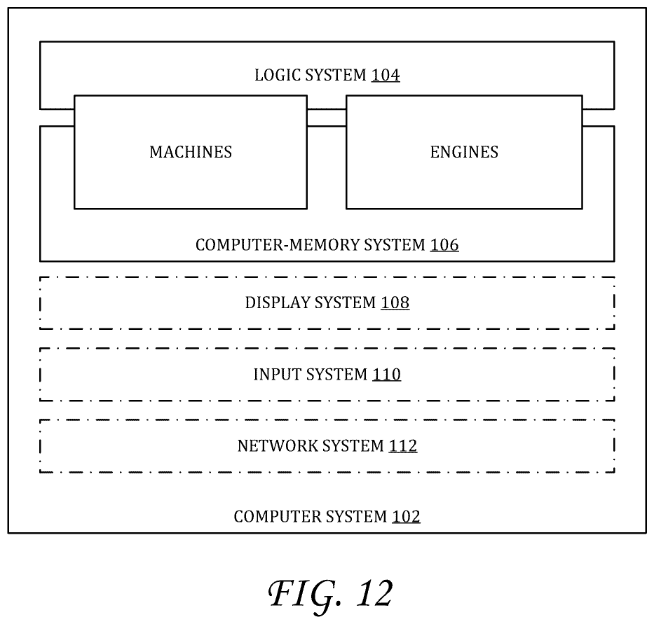

Generally speaking, communication scheduler 80 is a particularly configured component of a computer system—e.g., a computer system as illustrated in FIG. 12.

The methods herein may be tied to a computer system of one or more computing devices. Such methods and processes may be implemented as an application program or service, an application programming interface (API), a library, and/or other computer-program product.

FIG. 12 provides a schematic representation of a computer system 102 configured to provide some or all of the computer system functionality disclosed herein. computer system 102 may take the form of a personal computer, application-server computer, or any other computing device.

Computer system 102 includes a logic system 104 and a computer-memory system 106. computer system 102 may optionally include a display system 108, an input system 110, a network system 112, and/or other systems not shown in the drawings.

Logic system 104 includes one or more physical devices configured to execute instructions. For example, the logic system may be configured to execute instructions that are part of at least one operating system (OS), application, service, and/or other program construct. The logic system may include at least one hardware processor (e.g., microprocessor, central processor, central processing unit (CPU) and/or graphics processing unit (GPU)) configured to execute software instructions. Additionally or alternatively, the logic system may include at least one hardware or firmware device configured to execute hardware or firmware instructions. A processor of the logic system may be single-core or multi-core, and the instructions executed thereon may be configured for sequential, parallel, and/or distributed processing. Individual components of the logic system optionally may be distributed among two or more separate devices, which may be remotely located and/or configured for coordinated processing. Aspects of the logic system may be virtualized and executed by remotely-accessible, networked computing devices configured in a cloud-computing configuration.

Computer-memory system 106 includes at least one physical device configured to temporarily and/or permanently hold computer system information, such as data and instructions executable by logic system 104. When the computer-memory system includes two or more devices, the devices may be collocated or remotely located. Computer-memory system 106 may include at least one volatile, nonvolatile, dynamic, static, read/write, read-only, random-access, sequential-access, location-addressable, file-addressable, and/or content-addressable computer-memory device. Computer-memory system 106 may include at least one removable and/or built-in computer-memory device. When the logic system executes instructions, the state of computer-memory system 106 may be transformed—e.g., to hold different data.

Aspects of logic system 104 and computer-memory system 106 may be integrated together into one or more hardware-logic components. Any such hardware-logic component may include at least one program- or application-specific integrated circuit (PASIC/ASIC), program- or application-specific standard product (PSSP/ASSP), system-on-a-chip (SOC), or complex programmable logic device (CPLD), for example.

Logic system 104 and computer-memory system 106 may cooperate to instantiate one or more logic machines or engines. As used herein, the terms ‘machine’ and ‘engine’ each refer collectively to a combination of cooperating hardware, firmware, software, instructions, and/or any other components that provide computer system functionality. In other words, machines and engines are never abstract ideas and always have a tangible form. A machine or engine may be instantiated by a single computing device, or a machine or engine may include two or more subcomponents instantiated by two or more different computing devices. In some implementations, a machine or engine includes a local component (e.g., a software application executed by a computer system processor) cooperating with a remote component (e.g., a cloud computing service provided by a network of one or more server computer systems). The software and/or other instructions that give a particular machine or engine its functionality may optionally be saved as one or more unexecuted modules on one or more computer-memory devices.

Machines and engines may be implemented using any suitable combination of machine learning (ML) and artificial intelligence (AI) techniques. Non-limiting examples of techniques that may be incorporated in an implementation of one or more machines include support vector machines, multi-layer neural networks, convolutional neural networks (e.g., spatial convolutional networks for processing images and/or video, and/or any other suitable convolutional neural network configured to convolve and pool features across one or more temporal and/or spatial dimensions), recurrent neural networks (e.g., long short-term memory networks), associative memories (e.g., lookup tables, hash tables, bloom filters, neural Turing machines and/or neural random-access memory) unsupervised spatial and/or clustering methods (e.g., nearest neighbor algorithms, topological data analysis, and/or k-means clustering), and/or graphical models (e.g., (hidden) Markov models, Markov random fields, (hidden) conditional random fields, and/or AI knowledge bases)).

When included, display system 108 may be used to present a visual representation of data held by computer-memory system 106. The visual representation may take the form of a graphical user interface (GUI) in some examples. The display system may include one or more display devices utilizing virtually any type of technology. In some implementations, display system may include one or more virtual-, augmented-, or mixed reality displays.

When included, input system 110 may comprise or interface with one or more input devices. An input device may include a sensor device or a user input device. Examples of user input devices include a keyboard, mouse, or touch screen.

When included, network system 112 may be configured to communicatively couple computer system 102 with one or more other computer systems. The network system may include wired and/or wireless communication devices compatible with one or more different communication protocols. The network system may be configured for communication via personal-, local- and/or wide-area networks.

For additional context, the interested reader is directed to the following references, which are hereby incorporated by reference herein, for all purposes.
[Ref. 1] Aashaka Shah, Vijay Chidambaram, Meghan Cowan, Saeed Maleki, Madan Musuvathi, Todd Mytkowicz, Jacob Nelson, Olli Saarikivi, and Rachee Singh, “TACCL: Guiding Collective Algorithm Synthesis using Communication Sketches” arXiv (2021).
[Ref. 2] Zixian Cai, Zhengyang Liu, Saeed Maleki, Madanlal Musuvathi, Todd Mytkowicz, Jacob Nelson, and Olli Saarikivi, “Synthesizing Optimal Collective Algorithms” Proceedings of the 26th ACM SIGPLAN Symposium on Principles and Practice of Parallel Programming 62-75 (2021).
[Ref. 3] Guanhua Wang, Shivaram Venkataraman, Amar Phanishayee, Nikhil Devanur, Jorgen Thelin, and Ion Stoica, “Blink: Fast and generic collectives for distributed ml” Proceedings of Machine Learning and Systems 2, 172-186 (2020).
[Ref. 4] Weiyang Wang, Moein Khazraee, Zhizhen Zhong, Manya Ghobadi, Zhihao Jia, Dheevatsa Mudigere, Ying Zhang, and Anthony Kewitsch, “TopoOpt: Co-optimizing Network Topology and Parallelization Strategy for Distributed Training Jobs” arXiv (2022).
[Ref. 5] Kshiteej Mahajan, Ching-Hsiang Chu, Srinivas Sridharan, and Aditya Akella, “Better Together: Jointly Optimizing ML Collective Scheduling and Execution Planning using SYNDICATE”
[Ref. 6] Liangyu Zhao, Siddharth Pal, Tapan Chugh, Weiyang Wang, Prithwish Basu, Joud Khoury, and Arvind Krishnamurthy, “Optimal Direct-Connect Topologies for Collective Communications” arXiv (2022).
[Ref. 7] Jacob Devlin, Ming-Wei Chang, Kenton Lee, and Kristina Toutanova, “Bert: Pre-training of deep bidirectional transformers for language understanding” arXiv preprint arXiv:1810.04805 (2018).
[Ref. 8] Wei Deng, Junwei Pan, Tian Zhou, Deguang Kong, Aaron Flores, and Guang Lin, “DeepLight: Deep Lightweight Feature Interactions for Accelerating CTR Predictions in Ad Serving” Proceedings of the 14th ACM International Conference on Web Search and Data Mining 922-930 (2021).
[Ref. 9] “Azure NDv2-series” https://learn.microsoft.com/en-us/azure/virtual-machines/ndv2-series (2021).
[Ref. 10] “ChatGPT runs 10K Nvidia training GPUs with potential for thousands more” https://www.fierceelectronics.com/sensors/chatgpt-runs-10k-nvidia-training-gpus-potential-thousands-more (2023).
[Ref. 11] Alan Tang, Siva Kakarla, Reddy Kesava, Ryan Beckett, Ennan Zhai, Matt Brown, Todd Millstein, Yuval Tamir, and George Varghese, “Campion: Debugging Router Configuration Differences” Proceedings of the 2021 ACM SIGCOMM 2021 Conference 748-761 (2021).
[Ref. 12] Dimitris Bertsimas and John N. Tsitsiklis, “Introduction to linear optimization” Athena Scientific Belmont, MA 6 (1997).
[Ref. 13] Chi-Yao Hong, Srikanth Kandula, Ratul Mahajan, Ming Zhang, Vijay Gill, Mohan Nanduri, and Roger Wattenhofer, “Achieving High Utilization with Software-Driven WAN” Proceedings of the ACM SIGCOMM 2013 Conference on SIG-COMM 15-26 (2013).
[Ref. 14] Sushant Jain, Alok Kumar, Subhasree Mandal, Joon Ong, Leon Poutievski, Arjun Singh, Subbaiah Venkata, Jim Wanderer, Junlan Zhou, Min Zhu, et al, “B4: Experience with a globally-deployed software defined WAN” ACM SIGCOMM Computer Communication Review 43:4, 3-14 (2013).
[Ref. 15] Srikanth Kandula, Ishai Menache, Roy Schwartz, and Spandana Raj Babbula, “Calendaring for Wide Area Networks” Proceedings of the 2014 ACM Conference on SIGCOMM 515-526 (2014).
[Ref. 16] Nikolaos Laoutaris, Michael Sirivianos, Xiaoyuan Yang, and Pablo Rodriguez, “Inter-Datacenter Bulk Transfers with Netstitcher” Proceedings of the ACM SIGCOMM 2011 Conference 74-85 (2011).
[Ref. 17] C. A. Noronha and F. A. Tobagi, “Optimum routing of multicast streams” Proceedings of INFOCOM '94 Conference on Computer Communications 865-873 vol. 2 (1994).
[Ref. 18] M. Doar and I. Leslie, “How bad is naive multicast routing?” IEEE INFOCOM '93 The Conference on Computer Communications, Proceedings 82-89 vol. 1 (1993).
[Ref. 19] Roger W. Hockney, “The communication challenge for MPP: Intel Paragon and Meiko CS-2” Parallel computing 20:3, 389-398 (1994).
[Ref. 20] Firas Abuzaid, Srikanth Kandula, Behnaz Arzani, Ishai Menache, Matei Zaharia, and Peter Bailis, “Contracting wide-area network topologies to solve flow problems quickly” 18th USENIX Symposium on Networked Systems Design and Implementation (NSDI 21) 175-200 (2021).
[Ref. 21] Deepak Narayanan, Fiodar Kazhamiaka, Firas Abuzaid, Peter Kraft, Akshay Agrawal, Srikanth Kandula, Stephen Boyd, and Matei Zaharia, “Solving Large-Scale Granular Resource Allocation Problems Efficiently with POP” Proceedings of the ACM SIGOPS 28th Symposium on Operating Systems Principles 521-537 (2021).
[Ref. 22] John Matthew Simon Doar, “Multicast in the asynchronous transfer mode environment” University of Cambridge, Computer Laboratory (1993).
[Ref. 23] Stefan Hougardy, “The Floyd-Warshall algorithm on graphs with negative cycles” Information Processing Letters 110:8-9, 279-281 (2010).
[Ref. 24] Joo Pedro Pedroso, “Optimization with gurobi and python” INESC Porto and Universidade do Porto, Porto, Portugal 1 (2011).
[Ref. 25] Stephen Boyd and Lieven Vandenberghe, “Convex Optimization” Cambridge University Press (2004).
[Ref. 26] “Nvidia DGX System” https://www.nvidia.com/en-us/data-center/dgx-systems/ (2021).
[Ref. 27] “Gurobi Algorithm used to solve continuous models” https://www.gurobi.com/documentation/9.1/refman/method.html (2023).
[Ref. 28] “MSCCL codebase” https://github.com/microsoft/msccl
[Ref. 29] Carlos AS Oliveira and Panos M. Pardalos, “A survey of combinatorial optimization problems in multicast routing” Computers & Operations Research 32:8, 1953-1981 (2005).
[Ref. 30] Saeed Rashidi, William Won, Sudarshan Srinivasan, Srinivas Sridharan, and Tushar Krishna, “Themis: A Network Bandwidth-Aware Collective Scheduling Policy for Distributed Training of DL Models” Proceedings of the 49th Annual International Symposium on Computer Architecture 581-596 (2022).

### 8. Initialization and Termination Constraints

The main constraints for the MILP and LP formulations are introduced in Section 3 and Section 4.1. However, it is helpful to add a few additional constraints to initialize and terminate these problems.

### 8.0.1. The First Epoch

Buffers are used to indicate when the node has a specific chunk. In the first epoch of the MILP the source buffers are initialized as follows:

$$\begin{matrix}{B}_{n , n , 0 , c} = {max}_{d ∈ N} {D}_{n , d , c} & ∀ n ∈ N , ∀ c ∈ C \\ {B}_{s , n , 0 , c} = 0 & ∀ s , n ∈ N : s \neq n , ∀ c ∈ C\end{matrix}$$

It is no longer necessary to buffer the chunks already sent out in the LP form. Therefore these equations become:

$${B}_{s , n , 0} + {\sum }_{∀ j : ( n , j ) ∈ E} {F}_{s , n , j , 0} = {\sum }_{∀ c ∈ C , ∀ d ∈ N} {D}_{s , d , c} ∀ s , n ∈ N : s , n ∉ S$$

### 8.0.2. The Last Epoch

In the LP it is not necessary to buffer chunks if they are not going to be forwarded. Nodes also do not have to send out any traffic after this epoch. Therefore, in the last epoch of the LP:

$$∀ s , n ∈ N : s \neq n , n ∉ S {\sum }_{∀ j : ( j , n ) ∈ E} {F}_{s , j , n , ( K - ⌈ \frac{{α}_{j , n}}{τ} ⌉ )} = {R}_{s , n , K}$$

### 9. Modeling Limited Buffers

### 9.0.1. In the MILP

To model limited buffers in the MILP it is helpful to change the buffer constraints to track which chunks to remove from the buffer and in which epoch. Hence, a new variable X_{s,n,k,c} is introduced which encodes whether chunk c should be removed from node s from the buffer at node n in epoch k. The buffer constraints become:

$$Buffer constraints ( s , n , k , c ) {=}^{△} {B}_{s , n , k , c} = {B}_{s , n , k - 1 , c} - {X}_{s , n , k - 1 , c} + {\sum }_{∀ j \vert ( j , n ) ∈ E} {F}_{s , j , n , k - ⌈ {δ}_{j n} ⌉ - 1 , c} .$$

To enforce the limit on the buffer size, the following constraint is added:

$${\sum }_{s , c} {B}_{s , n , k , c} \leq ℒ \qquad ∀ n ∈ N , ∀ k ∈ K ,$$

where [symbol] is the limit on the buffer size. No limit is imposed on the auxiliary variable X_{s,n,k-1,c} as the algorithm can choose to re-buffer a chunk at a node at any point in time and again remove it later.

### 9.0.2. In the LP

The LP removes from the buffer what it sends out on a link. Hence, to use limited buffers only an upper limit is imposed on the sum of the buffer variables at a node:

$${\sum }_{s} {B}_{s , n , k} \leq ℒ \qquad ∀ n ∈ N , ∀ k ∈ K ,$$

### 10. Modeling Legacy Switches

For switches that do not support copy, an approach similar to TACCL's hyper-edges is used. The switch is removed from the topology and replaced with direct links between all pairs of GPUs that were connected through the switch. One now must account for the capacity to and from the switch: this translates to a upper bound on the number of hyper-edges it is possible to use simultaneously in each epoch. The notation hereinabove is augmented with the variables in Table 5. A constraint to the problem is added which enables use of only use a subset of the hyper-edges: the minimum of the number of edges that come into the switch and go out of it. This constraint is as follows:

$${\sum }_{∀ n ∈ N , ∀ c ∈ C , ∀ ( i , j ) ∈ Ω ( s )} {F}_{n , i , j , k , c} \leq min ( \vert \{ ( s , x ) ∈ E \} \vert , \vert \{ ( y , s ) ∈ E \} \vert )$$

$$∀ k ∈ K , ∀ s ∈ S$$

Each node i can only send (receive) traffic on one of its outgoing (incoming) hyper-edges:

$$∀ k ∈ K , ∀ i ∈ N , ∀ s ∈ S {\sum }_{∀ n ∈ N , ∀ c ∈ C , ∀ ( i , j ) ∈ Ω ( s )} {F}_{n , i , j , k , c} \leq 1$$

$$∀ k ∈ K , ∀ i ∈ N , ∀ s ∈ S {\sum }_{∀ n ∈ N , ∀ c ∈ C , ∀ ( j , i ) ∈ Ω ( s )} {F}_{n , i , j , k , c} \leq 1.$$

This model is only used in the general MILP form to ensure the solution can scale, as the LP model already assumes that none of the nodes copy traffic.

TABLE 5
Additional notation it is helpful to model legacy switches.

| Notation | Description |
|---|---|
| Γ | The function to get non-switch set of edges from the |
| | set of edges (Γ: E → E′). Therefore, E′ ⊂ 2^{N-S×N-S} and |
| | (i, j) ϵ E′ ⇒ (i, j) ϵ E \hat{ } i, j ∉ S. |
| Ω | The function from a switch node to the set of |
| | direct-connect edges (Ω: S → 2^{N-S×N-S}). |
| | Ω(s) = {(i, j)\|(i, s) ϵ E\hat{ }(s, j) ϵ E\hat{ }(i, j) ∉ E} |
| L | The set of edges in the transformed graph |
| | (L = Γ(E) ∪ U_{sϵS} Ω(s)). |

### 11. The A* Technique

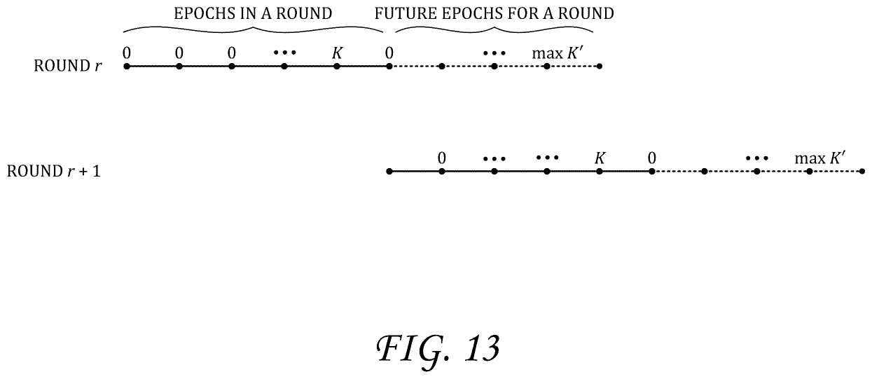

In the A* based approach the problem is split into multiple time partitions (or rounds). The goal in each round is to get the chunks closer to the destination. Each of these rounds is solved sequentially until all the demands are satisfied. The delay on each link (i.e., αᵢⱼ) means some chunks sent on link (i, j) in a particular round may arrive at node j in a subsequent round. The set K′ is used to denote all subsequent rounds and Q_{s,c,i,k′,r} is used to denote the chunks that arrive in these rounds to account for this (FIG. 13). To keep things simple, the number of epochs in a round is set in a way that ensures chunks are only delayed by a single round at most. This means the total duration of the round is greater than the largest link delay. However, users can choose to use shorter chunks, maintaining more state between rounds in that case.

TABLE 6
New variables for the A* technique.

| Variable | Description |
|---|---|
| R | The set of rounds (R = {0, 1, 2, . . . R}) |
| K | The set of epochs in a round (K = {0, 1, 2, . . . , K}). The |
| | number of epochs in a round is constant and does not change |
| | with the round. |
| K' | The set of future epochs relevant for a round |
| | $( {K}^{′} = \{ 0 , 1 , 2 , … , {max}_{∀ ( i , j ) ∈ E} ⌈ \frac{{α}_{i , j}}{τ} ⌉ \} )$ |
| D | The demand function (N × N × C → {0,1}) where D_{s,d,c,r} |
| | represents whether destination d wants chunk with id c from |
| | node s at the start of round r |
| F_{s,c,i,j,k,r} | (boolean) whether chunk c of source s is going over link |
| | (i, j) ∈ E at epoch k in round r |
| B_{s,c,i,k,r} | (boolean) whether chunk c of source s is in node i's buffer at |
| | the start of epoch k in round r |
| Q_{s,c,i,k,r} | (boolean) whether chunk c of source s is in node i's buffer at |
| | the start of future epoch k' in round r. |
| [symbol] _{s,c,d,k,r} | whether chunk c of source s is delivered to node d by the end |
| | of epoch kin round r |

FIG. 13 shows aspects of time progression between rounds using an implementation of the A* solver herein. To encode A* most constraints from the MILP formulation are maintained but the objective function and the buffer constraints are modified to account for chunks arriving in future rounds. For switches, it is helpful to modify the flow conservation constraints as they do not have enough memory for buffering.

### 11.0.1. Look Ahead Constraints

To account for chunks that will arrive in the subsequent epoch it is helpful to maintain additional state. For none switch nodes, if the chunk arrives in the first epoch of the next round (k′=0):

$${Q}_{s , n , c , 0 , r} = {Q}_{s , n , c , K , r} + {\sum }_{∀ j : ( j , n ) ∈ E} {F}_{s , j , n , c , K - ⌈ \frac{{α}_{j , n}}{τ} ⌉ , r}$$

$$∀ s , n ∈ N : n ∉ S , ∀ c ∈ C$$

and for all later arrivals:

$${Q}_{n , s , c , {k}^{′} , r} = {Q}_{n , s , c , {k}^{′} - 1 , r} + {\sum }_{∀ j : ( j , n ) ∈ E ∧ ( {k}^{′} - ⌈ \frac{{α}_{j , n}}{τ} ⌉ ) <= 0} {F}_{s , j , n , c , K + {k}^{′} - ⌈ \frac{{α}_{j , n}}{τ} ⌉ , r}$$

$$∀ s , n ∈ N : n ∉ S , ∀ c ∈ C , ∀ {k}^{′} ∈ {K}^{′} : {k}^{′} > 0.$$

These equations allow storage in the variables Q what chunks are arriving in the next round. Note that buffers are also accounted for by B_{s,n,c,K,r} in k′=0 and by Q_{s,n,c,k′-1,r} for the k′>0 case. Since the switches do not have large enough buffers the following is used:

$${Q}_{s , n , c , k , r} = {\sum }_{∀ j : ( j , n ) ∈ E ∧ ( {k}^{′} - ⌈ \frac{{α}_{j , n}}{τ} ⌉ ) <= 0} {F}_{s , j , n , c , K + {k}^{′} - ⌈ \frac{{α}_{j , n}}{τ} ⌉ , r}$$

$$∀ s , n ∈ N : n ∈ S , ∀ c ∈ C , {k}^{′} ∈ {K}^{′} .$$

Now the buffers are set at the beginning of each round r>0 to Q (r=0 is excluded since there is no prior round, and it is possible to use the same initialization that as used earlier):

$${B}_{s , n , c , 0 , r} = {Q}_{s , n , c , 0 , r - 1}$$

$$∀ s , n ∈ N : s \neq n ∧ n ∉ S , ∀ c ∈ C , r > 0$$

For k>0, if Q_{s,n,c,k-1,r-1}=0 and r>0, k<=max K′:

$$∀ s , n ∈ N : n ∉ S , ∀ c ∈ C , ∀ k ∈ K : k > 0$$

$${B}_{s , n , c , k , r} = {B}_{s , n , c , k - 1 , r} + {\sum }_{∀ j : ( j , n ) ∈ E} {F}_{s , j , n , c , k - ⌈ \frac{{α}_{j , n}}{τ} ⌉ - 1 , r +} {Q}_{s , n , c , k , r - 1}$$

otherwise:

$$∀ s , n ∈ N : n ∉ S , ∀ c ∈ C , ∀ k ∈ K : k > 0$$

$${B}_{s , n , c , k , r} = {B}_{s , n , c , k - 1} + {\sum }_{∀ j : ( j , n ) ∈ E} {F}_{s , j , n , c , k - ⌈ \frac{{α}_{j , n}}{τ} ⌉ - 1}$$

Specifically, what is arriving from the previous round is added to the buffer. The two cases are there to ensure that each arrival is accounted for only once for non-switch nodes. The equations are similar for switches:

$$∀ s , n ∈ N : n ∈ S , ∀ k ∈ K : k > 0 , ∀ c ∈ C$$

$${max}_{∀ j : ( n , j ) ∈ E} {B}_{s , n , j , c , k , r} \leq \{ \begin{matrix}{\sum }_{∀ j : ( j , n ) ∈ E} {F}_{s , j , n , c + k - ⌈ \frac{{α}_{j , n}}{τ} ⌉ - 1} + {Q}_{s , n , c , k , r - 1} & r > 0 , k < = max {K}^{′} \\ {\sum }_{∀ j : ( j , n ) ∈ E} {F}_{s , j , n , c + k - ⌈ \frac{{α}_{j , n}}{τ} ⌉ - 1} & othe rwise\end{matrix}$$

but since switches do not buffer chunks, they are incorporated into the flow conservation constraints.

### 11.0.2. The Objective

The optimization is now motivated in each round to get the chunks closer to the destination (while making it even more profitable to satisfy the demand fully). So first, it is helpful to automatically compute this additional payoff. To do this, logical edges are added to the graph that allow nodes to form a clique. A weight is assigned to each of these edges which are calculated using the Floyd Warshall algorithm [Ref. 23] and the values for αᵢⱼ. The chunks sent in this epoch that do not contribute to satisfying a demand are stored in the Q variables. A new variable P_{s,d,k′,r} is now introduced, which is the total number of chunks coming from source s and going towards destination d that are currently on their way towards the destination:

$${P}_{s , d , {k}^{′} , r} \leq {\sum }_{∀ n ∈ N , ∀ c ∈ C : {D}_{n , d , c , r ,} = 1} {Q}_{n , s , c , {k}^{′} , r} ∀ {k}^{′} ∈ {K}^{′} , ∀ s , d ∈ N$$

$${\sum }_{∀ s ∈ N} {P}_{s , d , {k}^{′} , r} = {\sum }_{∀ s ∈ N , ∀ c ∈ C} {D}_{s , d , c , r} ∀ {k}^{′} ∈ {K}^{′} , ∀ d ∈ N$$

Also modify the demands are modified from round to round to remove the demands already satisfied. For r>0:

$$∀ s , d ∈ N , ∀ c ∈ C$$

$${D}_{s , d , c , r} = \{ \begin{matrix}0 & {D}_{s , d , c , r - 1} = {Q}_{s , d , c , max {K}^{′} , r - 1} = 1 \\ {D}_{s , d , c , r - 1} & otherwise\end{matrix}$$

Given these new values of D and P it is possible to now add the following to the objective:

$$Distance Objective ( r ) = {\sum }_{∀ {k}^{′} ∈ {K}^{′} , ∀ s , d ∈ N : s \neq d} \frac{γ}{( {k}^{′} + 1 ) ( 1 + {FW}_{s , d} )} {P}_{s , d , {k}^{′} , r} + {\sum }_{∀ {k}^{′} ∈ {K}^{′} , ∀ s , d ∈ N : s = d} \frac{1}{( {k}^{′} + 1 )} {P}_{s , d , {k}^{′} , r}$$

where the second term ensures having the chunk at the destination gives more payoff to the optimization (γ<1).

### 12. Number of Epochs

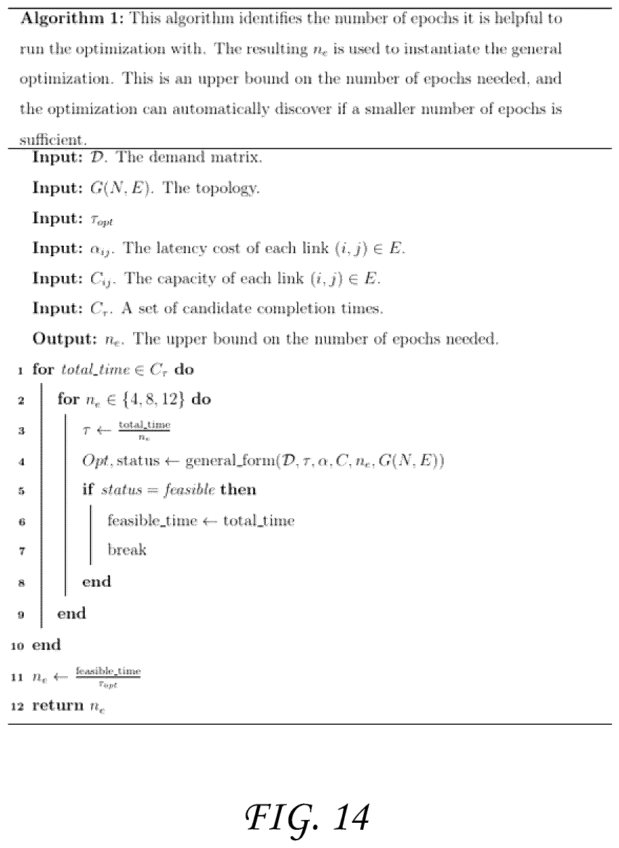

FIG. 14 provides an example algorithm for finding the number of epochs to run the optimization with. This algorithm has no bearing on the optimality of the solution as the optimization automatically identifies if less epochs are sufficient.

TABLE 7
Comparing TE-CCL's runtime to SCCL. 25 KB chunks are used for
these experiments and α = 0. The difference in transfer time is
$\frac{100 ( SCCL - TECCL )}{SCCL} . For all ‐ to ‐ all the notation from this$
disclousre is used. The number chunks represents the number of
chunks the sender wants to send to each destination. By contrast,
in SCCL the number of chunks refers to the total number of
chunks the source must send.
Collective (# chunks, SCCL solver time (s) TE-CCL solver time (s)
Diff in transfer time (%) # epochs)

| | | | | |
|---|---|---|---|---|
| ALLGATHER | (1,2) | 0.3 | 0.09 | 0 |
| | (2,3) | 0.7 | 0.07 | 0 |
| | (3,4) | 1.8 | 0.19 | 0 |
| | (4,5) | 4.1 | 1.45 | 0 |
| | (5,6) | 11.2 | 8.96 | 0 |
| | (6,7) | 27.7 | 50.57 (11s) | 0 |
| ALLTOALL | (1,3) | 8.8 | 0.11 | 33% |
| | (3,8) | NA | 0.18 | NA |
| | (8,30) | NA | 1.88 | NA |

### 13. Epoch Duration Set Based on the Fastest Link

To set the epoch duration based on the speed of the fastest link in the LP it is not necessary to change anything. The LP supports fractional chunks and handles this automatically. The MILP only allows us to send whole chunks; if the epoch duration is set to be lower than the transmission time of the chunk on the slowest link, then it is possible to never use that link. It is helpful to modify both the flow conservation constraint and the capacity constraints to address this issue.

The flow conservation constraints are modeled similarly to α; the number epochs it takes a chunk to traverse the slowest link is accounted for and the value of δᵢⱼ is changed accordingly. To model the capacity constraint, it is helpful to ensure the number of chunks on a link never exceed its capacity. The number of epochs for transmitting the chunk over a link (κ) is first calculated, and the capacity constraints are modified to:

$$Capacity Constraint ( i , j , k ) {\_}_{}$$

$${\sum }_{k - K \leq {k}^{′} \leq k} {\sum }_{s ∈ N} {\sum }_{c ∈ C} {F}_{s , i , j , {k}^{′} , c} \leq {KT}_{ij} τ$$

Notice that this capacity constraint ensures the same behavior as when the larger epoch duration was used.

This disclosure is presented by way of example and with reference to the attached drawing figures. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

This disclosure uses the terms ‘optimize’, ‘minimize’, and variants thereof. These terms are to be understood in the context of numerical analysis and relevant subfields (e.g., linear and non-linear programming), not in any narrower sense. More specifically, a linear order may be regarded as ‘optimized’ if its cost of execution is lower than the cost of execution of other, suitably sampled, candidate linear orders. Accordingly, the existence of an ‘optimized’ linear order does not preclude the possibility that an undiscovered linear order may execute at still lower cost. Likewise, a function is ‘minimized’ if at least a local minimum is found within a relevant parameter space. Although a numerical algorithm may be configured to avoid being trapped in local minima, so as to arrive at a global minimum over the relevant parameter space, a function may still be regarded as ‘minimized’ even if an undiscovered lower value of the function exists elsewhere in the parameter space.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for scheduling a coordinated transfer of data among a plurality of processor nodes on a network, the method comprising:
operating a multi-commodity flow model subject to a plurality of predetermined constraints, the model being configured to—
receive as input a set of demands defining, for each of the plurality of processor nodes, an amount of data to be transferred to that processor node,
assign a plurality of paths linking the plurality of processor nodes, and
emit a schedule for transfer of the data along the plurality of paths so as to minimize a predetermined cost function, wherein the schedule comprises at least one store-and-forward operation and at least one copy operation.

2. The method of claim 1 wherein the data includes a plurality of weighting factors of a machine-learning model, and wherein the weighting factors are computed by the plurality of processor nodes.

3. The method of claim 1 wherein each of the plurality of processor nodes comprises a graphics processing unit (GPU).

4. The method of claim 1 wherein the predetermined cost function comprises a length of time for completion of the coordinated transfer of data and/or a metric of processor disuse.

5. The method of claim 1 further comprising emitting an optimality-gap guarantee for the schedule based on a primal-dual theorem.

6. The method of claim 1 wherein the model is formulated as a mixed-integer linear program (MILP).

7. The method of claim 6 further comprising converting the MILP into a linear program (LP), wherein said converting includes removing all integer variables.

8. The method of claim 1 wherein the cost function is minimized in dependence on a data-transfer latency for each of the plurality of processor nodes.

9. The method of claim 8 wherein at least two of the plurality of processors differ in the data-transfer latency.

10. The method of claim 1 wherein the set of demands comprise an ALLTOALL demand, an ALLGATHER demand, or an ALLREDUCE demand.

11. The method of claim 1 wherein the plurality of predetermined constraints include, for each processor node, a capacity constraint, a flow-conservation constraint, and a destination constraint.

12. The method of claim 11 wherein the flow-conservation constraint includes a buffer constraint.

13. The method of claim 1 wherein the cost function is adapted to discourage unnecessary data transfer during operation of the model.

14. The method of claim 1 wherein the model is configured to operate within successive partitions of time, and wherein minimizing the cost function includes maximizing progress toward completion of the coordinated transfer of data within a current partition.

15. The method of claim 1 wherein the set of demands comprises a sum of demands across a plurality of collectives in a multi-tenant cluster on the network.

16. The method of claim 15 wherein the multi-tenant cluster services demands of first and second tenants, and wherein the predetermined cost function is adapted to prioritize the demands of the first tenant over the demands of the second tenant.

17. A communication scheduler for a machine-learning collective of a plurality of graphics processing unit (GPU) clusters arranged on a network, the communication scheduler comprising:
an input engine configured to furnish a set of demands defining, for each of the plurality of GPUs, an amount of data to be transferred to that GPU;
a multi-commodity flow model formulated to operate within a plurality of predetermined constraints and configured to—
receive the set of demands as input from the input engine,
assign a plurality of paths linking the plurality of GPUs, and
emit a schedule for transfer of the data along the plurality of paths so as to minimize a predetermined cost function, wherein the schedule comprises at least one store-and-forward operation and at least one copy operation; and
an output engine configured to output the schedule, together with an optimality-gap guarantee for the schedule.

18. A method for scheduling a coordinated transfer of a plurality of weighting factors of a machine-learning model among a plurality of graphics processing units (GPUs) on a network, the method comprising:
operating a multi-commodity flow model subject to a plurality of predetermined constraints, the model being configured to—
receive as input a set of demands defining, for each of the plurality of GPUs, an amount of data to be transferred to that GPU,
assign a plurality of paths linking the plurality of GPUs, and
emit a schedule for transfer of the data along the plurality of paths so as to minimize a predetermined cost function, wherein the schedule comprises at least one store-and-forward operation and at least one copy operation, each employing cache memory of the plurality of GPUs.

19. The method of claim 18 wherein the copy operation supports multicasting to two or more of the plurality of GPUs.

20. The method of claim 18 wherein the model is further configured represent a plurality of switches configured to connect different blocks of GPUs on the network.
